(19) United States
(12) Patent Application Publication
(10) Pub. No.: US 2019/0222875 A1
(43) Pub. Date: Jul. 18, 2019

(54) INFORMATION PROCESSING DEVICE, INFORMATION PROCESSING METHOD, AND NON-TRANSITORY COMPUTER-READABLE STORAGE MEDIUM

(71) Applicant: Yahoo Japan Corporation, Tokyo (JP)

(72) Inventor: Motoki SHIMIZU, Tokyo (JP)

(21) Appl. No.: 16/246,074

(22) Filed: Jan. 11, 2019

(30) Foreign Application Priority Data
Jan. 15, 2018 (JP) 2018-004461

(51) Int. Cl. H04N 21/234; H04N 21/24; H04N 21/81; H04N 21/262

(52) U.S. Cl. CPC H04N 21/23424; H04N 21/24; G06F 16/70; H04N 21/26208; H04N 21/812

(57) ABSTRACT

An information processing device according to the application concerned includes a control unit that generates a plurality of sets of configuration information, each of which contains sets of location information from a plurality of sets of partitioned content obtained by partitioning first-type content that includes videos and/or sounds, and that includes a second-type content within a reproduction range.

### CROSS-REFERENCE TO RELATED APPLICATION

The present application claims priority to and incorporates by reference the entire contents, of Japanese Patent Application No. 2018-004461, filed in Japan on Jan. 15, 2018.

### BACKGROUND

### 1. Field

Example implementations are directed to an information processing device, an information processing method, and a non-transitory computer-readable storage medium.

### 2. Related Art

A related art technology allows for insertion of the content such as advertisements (hereinafter, called inserted content) in between the content such as videos (hereinafter, called main content). For example, regarding web-based video streaming, a related art technology called CSAI (i.e., Client-Side Ad Insertion) allows for insertion of advertisements in between videos on the client side (e.g., terminal device side). However, in the related art CSAI technology, the client side comes under a heavy load. Hence, in recent years, the related art SSAI technology (i.e., Server-Side Ad Insertion) is also attracting attention because it permits linking of videos and advertisements on the server side and permits delivery of the linking result as a single video to terminal devices (for example, see Japanese Laid-open Patent Publication No. 2014-216918).

However, if the main content and the inserted content (e.g., advertisements) are linked on the server side, then the reproduction of the content becomes freely controllable on the terminal device side, thereby allowing the user to substantially skip the portions of the inserted content. That leads to a situation in which it is not possible to require the user to view the portions in the content (e.g., advertisements) that are expected to be viewed by the user.

### SUMMARY

According to one aspect of an example implementation, an information processing device includes a generating unit that generates a plurality of sets of configuration information, each of which contains some sets of location information from among sets of location information of a plurality of sets of partitioned content obtained by partitioning first-type content that includes at least either videos or sounds and that includes second-type content within a reproduction range (e.g., predetermined).

The above and other objects, features, advantages and technical and industrial significance will be better understood by reading the following detailed description of example implementations, when considered in connection with the accompanying drawings.

### BRIEF DESCRIPTION OF THE DRAWINGS

FIG. 1 is a diagram illustrating the operations performed in a delivery system according to an example implementation;

FIG. 2 is a diagram illustrating main content and advertisement content;

FIG. 3 is a diagram illustrating content for delivery for which reproduction ranges (e.g., predetermined) in the main content serve as advertisement reproduction ranges;

FIG. 4 is a diagram illustrating a plurality of sets of partitioned content obtained by partitioning the content for delivery;

FIG. 5 is a diagram illustrating an example of configuration information;

FIG. 6 is a diagram illustrating the sequence in which the configuration information is provided (e.g., sent) in response to skipping of the content in the midway;

FIG. 7 is a diagram illustrating the manner in which information is communicated between a delivery server and a terminal device;

FIG. 8 is a diagram illustrating an example configuration of the delivery server according to the example implementation;

FIG. 9 is a diagram illustrating an example of the information stored in a content database according to the example implementation;

FIG. 10 is a diagram illustrating an example of the information stored in an advertisement database according to the example implementation;

FIG. 11 is a diagram illustrating an example configuration of the terminal device according to the example implementation;

FIG. 12 is a flowchart for explaining an example of the delivery operation;

FIG. 13 is a flowchart for explaining another example of the delivery operation; and

FIG. 14 is a diagram illustrating an example hardware configuration of a computer that implements the functions of the delivery server.

### DETAILED DESCRIPTION

An illustrative example implementation (hereinafter, called an example implementation) of an information processing device, an information processing method, and a non-transitory computer-readable storage medium according to the application concerned is described below in detail with reference to the accompanying drawings. However, the information processing device, the information processing method, and the non-transitory computer-readable storage medium according to the application concerned are not limited by the example implementation described below. Moreover, in the example implementation described below, the identical portions are referred to by the same reference numerals, and the redundant explanation is not repeated.

### 1. OPERATIONS OF INFORMATION PROCESSING DEVICE

The operations performed by an information processing device according to the present example implementation are explained with reference to a delivery system 1 that includes a delivery server 30 representing an example of the information processing device.

1-1. System Configuration

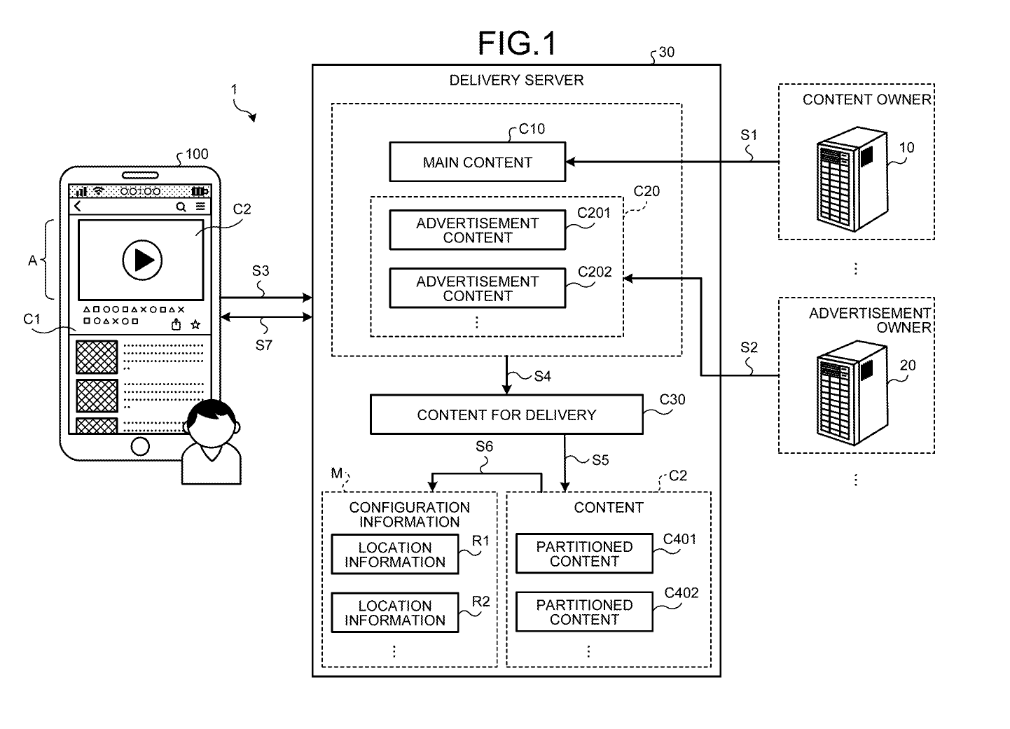

FIG. 1 is a diagram illustrating the operations performed in the delivery system 1 according to the example implementation. The delivery system 1 includes a terminal device 100, a content owner server 10, an advertisement owner server 20, and the delivery server 30. In the example illustrated in FIG. 1, there is a single terminal device 100, a single content owner server 10, a single advertisement owner server 20, and a single delivery server 30. However, each device can be installed in plurality.

Examples of the terminal device 100 include user devices such as a smart device (a smartphone or a tablet); a cellular phone; and a personal computer (a desktop PC (i.e., personal computer) or a laptop PC). In the example illustrated in FIG. 1, although the terminal device 100 is understood to be a smart device, the example implementation is not limited thereto. The terminal device 100 is equipped with a network connection function for communicating with server devices (e.g., arbitrary) via a network. In the example illustrated in FIG. 1, the terminal device 100 communicates with the delivery server 30 via a network. In the example illustrated in FIG. 1, the screen of the terminal device 100 is understood to be a touch-sensitive panel. In response to a user operation of the touch-sensitive panel, the terminal device 100 displays the content on the screen.

The terminal device 100 obtains information of the content from the delivery server 30. Then, the terminal device 100 displays the content of the screen. In the example illustrated in FIG. 1, on the display screen (hereinafter, called the screen) of the terminal device 100, content C1 is displayed in which a plurality of sets of content is arranged. The content C1 represents the information of a layout screen in which content such as images (for example, static images and videos) and text information (for example, news articles) are arranged. For example, the content C1 represents information of the screen to be displayed in an application installed in the terminal device 100. In the content C1, a plurality of sets of content is arranged in a tiled manner. The content C1 can be generated based on the data (for example, content data such as map data) that is installed in advance in a memory device of the terminal device 100. Alternatively, the content C1 can be the information of a page (for example, the information of a webpage).

The content owner server 10 is a server operated by a content owner. For example, a content owner represents a content partner of the operator of the delivery server 30 (hereinafter, called the operator). A content partner is an entity that provides the content to the operator. Examples of a content partner include a movie distribution company, a television company, a radio company, a video production company, a record company, a newspaper company, and a news agency. Of course, a content partner is not limited to these examples. A content person can be a corporate body or can be an individual person. Moreover, a content owner can be the operator himself or herself, or can be an entity (for example, a subsidiary company) under the control of the operator. A content owner provides the main content (for example, main content C10 illustrated in FIG. 1) to the delivery server 30. The main content represents the original delivery objective intended by an application or a webpage. In the example implementations, the content owner server 10 provides, to the delivery server 30, video content such as movies and television programs serving as the main content (first-type content). The main content can be a streaming video. Alternatively, the main content can be an archive video, or can be a real-time video that is streamed on a real-time basis.

The advertisement owner server 20 is a server operated by an advertisement owner. An advertisement owner can be a providing entity (for example, a business enterprise or an individual person that provides a product or a service to be advertised, or can be an agency as a representative of the providing entity). Of course, an advertisement agent can be the operator himself or herself, or can be an entity (for example, a subsidiary company) under the control of the operator. The advertisement owner server 20 provides advertisement content to the delivery server 30. For example, the advertisement owner server 20 provides advertisement content C20 illustrated in FIG. 1 to the delivery server 30. In the advertisement content C20, a plurality of sets of advertisement content (advertisement content C201 and advertisement content C202 illustrated in FIG. 1) is provided. In the example implementations, the advertisement owner server 20 provides, to the delivery server 30, video content such as promotional videos as the advertisement content (e.g., second-type content).

The delivery server 30 is a host computer for servers meant for providing various services to client terminals (for example, the terminal device 100). For example, the delivery server 30 is a server device that delivers information about webpages to the terminal device 100. For example, the delivery server 30 is a delivery device that delivers, to the terminal device 100, content (e.g., an application screen or a webpage) in which information related to portal websites, game information delivery websites, news websites, auction sites, weather forecast websites, shopping websites, finance (e.g., stock) websites, railway route search websites, map providing websites, travel websites, restaurant introduction websites, and web blogs is arranged in a tiled manner.

In the example implementations, the delivery server 30 delivers the content C1 to the terminal device 100. The content C1 represents, for example, the content (for example, an application screen) optimized for a smart device. In the content C1, for example, various types of content such as news, weather forecast, index and details of received emails, and photo viewer are arranged. Meanwhile, the content C1 is not limited to an application screen. Alternatively, for example, the content C1 can be a webpage optimized for a smart device. In that case, the content C1 can be written in the HTML (i.e., Hyper Text Markup Language) or the XML (i.e., Extensible Markup Language).

In the example illustrated in FIG. 1, content C2 is placed in the content C1. The content C2 is placed in a display area A in the content C1. The content C2 represents video content. For example, the content C2 represents the content for delivery formed by inserting the advertisement content C20 (e.g., the second-type content) at a position, such as a predetermined position (a reproduction timing such as a predetermined reproduction timing) in the main content C10 (e.g., the first-type content). That is, the content C2 represents the main content C10 having the advertisement content C20 inserted therein. If the main content C10 represents the first-type content, then the content C2 also represents the first-type content. The advertisement content C20 includes a plurality of sets of advertisement content (e.g., the advertisement content C201 and the advertisement content C202). Each of the plurality of sets of content is placed at a different position in the content C30 for delivery. Herein, the content C30 for delivery can also be treated as the first-type content.

In the following explanation, the main content C10, the content C30 for delivery, and the content C2 are referred to as the first-type content. Moreover, in the following explanation, the advertisement content C20 along with a plurality of sets of advertisement content included in the advertisement content C20 is referred to as the second-type content. The first-type content as well as the second-type content is sent (e.g., provided) in response to a request from a client (for example, the terminal device 100) and represents, what is called, the content for automatic public transmission. For example, the first-type content as well as the second-type content is a video content.

The delivery server C30 sends the content C1 and the content C2 as well as sends control information meant for controlling the terminal device 100. The control information can be a computer program (e.g., non-transitory computer readable medium including stored instructions executed by a microprocessor) written for controlling the applications installed in the terminal device 100, or can be a computer program embedded in a webpage. For example, the control information can be a computer program written in a script language such as JavaScript (registered trademark). The control information can be information written in some other computer language other than a script language. For example, the control information can be information written in a style sheet language such as CSS3 (i.e., Cascading Style Sheets 3). Alternatively, the control information can be a computer program (e.g., non-transitory computer readable medium including stored instructions executed by a microprocessor) written and compiled in a programming language such as Java (registered trademark), Swift, C, or C++. Still alternatively, the application software delivered from a server such as a delivery server can itself be treated as the control information. At that time, the information of the content (for example, the information of a webpage) can be included in the control information. Of course, the control information can be a part of the content C1 and the content C2. Meanwhile, as long as the terminal device 100 is able to eventually execute a computer program, the control information need not be a compiled computer program. Other than that, the control information can be data (a computer program, non-transitory computer readable medium including stored instructions executed by a microprocessor) provided in the format of an interpretive language (for example, a script language), a machine language, or an intermediate language.

Meanwhile, as far as the method for inserting advertisements is concerned, there is a method called CSAI (i.e., Client-Side Ad Insertion) in which advertisements are inserted on the client side, and there is a method called SSAI (i.e., Server-Side Ad Insertion) in which advertisements are inserted on the server side. A CSAI-type video delivery server separately sends the main content and the advertisement content to a client terminal (for example, the terminal device 100), and sends control information to the client terminal so as to permit insertion of the advertisement content in the main content on the client side. On the other hand, an SSAI-type video delivery server inserts the advertisement content in the main content on the server side. Then, the SSAI-type video delivery server sends, to a client terminal, the main content having the advertisement content inserted therein or the main content in which the insertion points for the advertisement content (or the reproduction ranges for advertisements) are determined (in the following explanation, such content is collectively referred to as content for delivery).

The delivery server 30 according to the example implementations is an SSAI-type video delivery server. For example, the delivery server 30 delivers videos according to the HTTP streaming method in which videos are delivered using the HTTP (i.e., Hyper Text Transfer Protocol). As an example, the delivery server 30 delivers videos according to the MPEG-DASH method (i.e., MPEG Dynamic Adaptive Streaming over HTTP). As a result of the SSAI-type video delivery, the terminal device 100 becomes able to reproduce the videos in a smooth manner without any unnatural waiting period between the main chapter and the advertisements.

The content for delivery is partitioned into a plurality of sets of partitioned content (for example, partitioned videos). Then, the delivery server 30 delivers, to the terminal device 100, configuration information that contains the location information of the sets of partitioned content. Subsequently, the terminal device 100 issues a delivery request to a server (e.g., predetermined server) according to the configuration information and requests for the delivery of the sets of partitioned content. That is, the terminal device 100 reproduces the content C2 based on the location information. In the present example implementation, although the server that delivers the configuration information is same as the server that delivers the sets of partitioned content, it is also possible to have two different servers. For example, if the delivery server 30 sends the location information to the terminal device 100, the server that delivers the sets of partitioned content can be different than the delivery server 30.

The location information represents information such as a URL (i.e., Uniform Resource Locator) indicating the storage location of the partitioned content. The configuration information represents information indicating the configuration of the content to be delivered to the user. In the MPEG-DASH method, the configuration information is represented by MPD files (i.e., Media Representation Description). However, as long as the location information of the partitioned content is included therein, the configuration information is not limited to MPD files. Moreover, when the delivery server 30 delivers videos according to the MPEG-DASH method, the sets of partitioned content can be segments, or periods, or groups. Of course, the sets of partitioned content can be GOP (i.e., Group of Picture). Meanwhile, the unit of partitioning the content for delivery can be a unit (e.g., arbitrary).

1-2. Operations of Delivery System

Explained below with reference to FIG. 1 are the operations performed in the delivery system 1.

Firstly, the delivery server 30 obtains the main content C10 (the first-type content) from the content owner server 10 (S1). As described earlier, the main content C10 is sent in response to a request from a client and represents, what is called, the content for automatic public transmission.

Then, the delivery server 30 obtains the advertisement content C20 (the second-type content) from the advertisement owner server 20 (S2). As described above, the advertisement content C20 is made of a plurality of sets of advertisement content (the advertisement content C201 and the advertisement content C202). Each set of advertisement content can be treated as the second-type content. For example, the sets of advertisement content represent video content. The advertisement content is inserted at a reproduction position (e.g., predetermined reproduction position) in the main content. If a plurality of sets of advertisement content is inserted in the main content, then each set of advertisement content is inserted at a different reproduction position in the main content.

When the user operates the terminal device 100 and accesses the delivery server 30, the terminal device 100 receives the delivery of the content C1 from the delivery server 30. Then, the terminal device 100 displays the content C1 on the screen. Moreover, upon receiving the delivery of the content C1, according to control information that was sent along with the content C1, the terminal device 100 sends a delivery request to the delivery server 30 for requesting the delivery of the content C2 (S3). The content C2 that is delivered to the terminal device 100 is video content. In the present example implementation, the content C2 is configured with the main content having the advertisement content has been inserted therein.

Meanwhile, the advertisement content inserted in the main content can be different for each client that requests for content. For example, as the advertisement content (e.g., the second-type content) to be inserted in the main content, the delivery server 30 obtains the advertisement content selected from among a plurality of sets of advertisement content based on the information about the client that requested for the main content. The information about the client implies, for example, user information. For example, the user information represents the demographic information or the psychographic information related to the user. As a specific example, the user information represents the following information about the user: the age, the occupation, the income, the assets, the address, the business address, the used language, the family structure, the relationships with friends, the lifecycle, the set of values, the lifestyle, the personality makeup, the preferences, and the changes in those attributes. Alternatively, the user information can be the history of the content (such as videos, music, news articles, and webpages) viewed in the past by the user. The delivery server 30 can obtain the user information from the terminal device 100 (for example, the cookies of the web browser); or can store in advance the user information in a memory device of the delivery server 30 and can obtain the user information based on user identification information obtained from the terminal device 100.

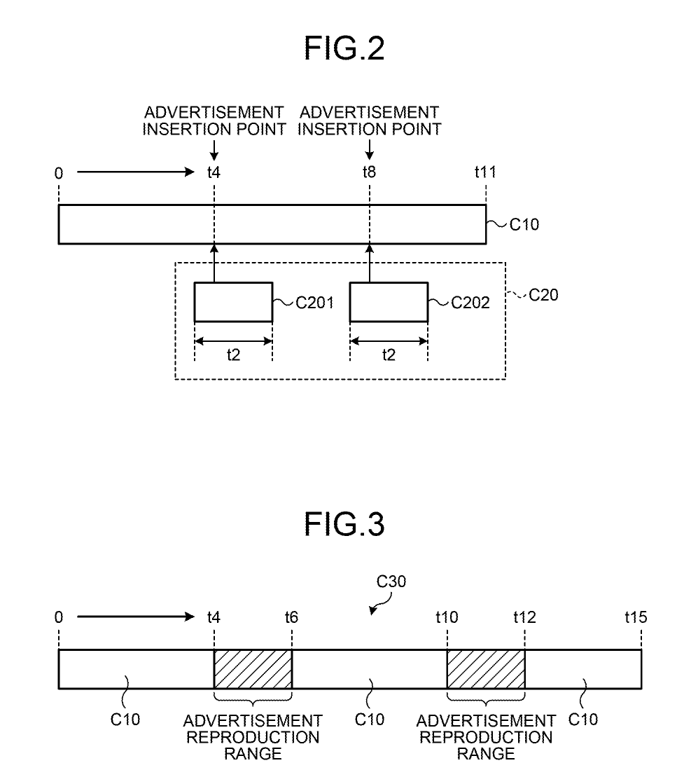

The content C2 for delivery is generated by the delivery server 30. Given below is the explanation of the operation of generating the content C2. Firstly, the delivery server 30 inserts the advertisement content C201 and the advertisement content C202 at reproduction positions (e.g., predetermined reproduction positions) in the main content C10, and generates the content C30 for delivery (S4). FIG. 2 is a diagram illustrating the main content C10 as well as the advertisement content C201 and the advertisement content C202. In the example illustrated in FIG. 2, the main content C10 represents video content having the reproduction period till a timing t11. The advertisement content C201 and the advertisement content C202 represent sets of video content having the reproduction period of t2. In the example illustrated in FIG. 2, the delivery server 30 inserts the advertisement content C201 at the position of a reproduction timing t4, and inserts the advertisement content C202 at the position of a reproduction timing t8.

Meanwhile, the present example implementation is only an example and can be modified in various ways. For example, the delivery server 30 need not always insert the advertisement content in the main content C10 during the process of generating the sets of partitioned content. Alternatively, for example, it is sufficient if the delivery server 30 determines in advance on the unit of partitioning the content C30 for delivery and determines the advertisement insertion points (or the advertisement reproduction range). Moreover, the delivery server 30 can determine the advertisement content, which is to be inserted in the main content C10, immediately before the delivery of the advertisement content. For example, after the location information (described herein) is sent to the terminal device 100 or after there is a request from the terminal device 100 for the content based on the location information, the delivery server 30 can determine the advertisement content to be delivered to the terminal device 100 (e.g., the advertisement content to be inserted in the advertisement reproduction ranges). Of course, the delivery server 30 can determine the advertisement content, which is to be delivered to the terminal device 100 (the advertisement content to be inserted in the advertisement reproduction range), after there is request from the terminal device 100 for the location information of the advertisement reproduction ranges. That is, as long as the delivery server 30 is capable of storing or accessing the timings of reproducing the advertisement content (e.g., the advertisement insertion timings) in the main content C10, it serves the purpose.

In the case in which the advertisement content to be assigned to the content C30 for delivery (the advertisement content to be inserted at the advertisement reproduction positions) is determined before the start of the delivery of the content C30 for delivery; if the user does not reproduce the content C30 for delivery till the position of the advertisement content, then the user may not view the advertisement content in spite of it having been assigned. In that case, by taking into account the possibility that the assigned advertisement content is not viewed by the user, it becomes necessary for the operator of the delivery server 30 to perform inventory management of advertisements (for example, management of the display count of the concerned advertisement content), thereby making it difficult to perform inventory management of advertisements. However, as a result of assigning the advertisement content immediately before the delivery, it becomes possible to get the user to view the assigned advertisement content, thereby making it extremely easy to perform inventory management of advertisements. Besides, regarding the advertisement content not reproduced often (i.e., the advertisement content having a large inventory), it also becomes possible to assign such advertisement content immediately before entering an advertisement reproduction range, thereby making it extremely easy to perform inventory management of advertisements.

FIG. 3 is a diagram illustrating the content C30 for delivery for which reproduction ranges (e.g., predetermined reproduction ranges) in the main content C10 serve as the advertisement reproduction ranges. In the example illustrated in FIG. 3, the content C30 for delivery has the reproduction period till a timing t15. The reproduction range from the reproduction position t4 to a reproduction position t6 and the reproduction range from a reproduction position t10 to a reproduction position t12 represent the advertisement reproduction ranges (e.g., predetermined reproduction ranges). In the examples illustrated in FIGS. 2 and 3, although there are two advertisement reproduction ranges (or advertisement insertion points) provided in the main content C10, there can be more than two advertisement reproduction ranges (or advertisement insertion points) in the main content C10. Of course, there can be only one advertisement reproduction range (or advertisement insertion point) in the main content C10.

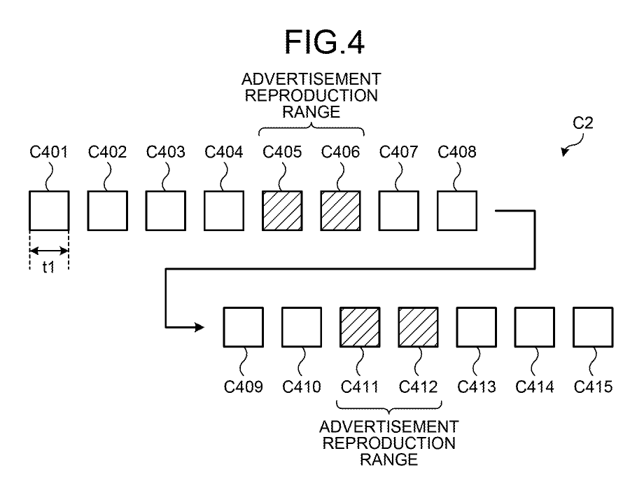

Subsequently, the delivery server 30 partitions the content C30 for delivery (or the main content C10) into a plurality of sets of content (S5). Each set of content obtained by partitioning represents partitioned content. FIG. 4 is a diagram illustrating partitioned content C401 to partitioned content C415 obtained by partitioning the content C30 for delivery. In the example illustrated in FIG. 4, although the content C30 for delivery is partitioned into 15 sets of partitioned content, the number of partitions can be greater or smaller than 15. In the example illustrated in FIG. 4, each set of partitioned content has the reproduction period of t1. Alternatively, the reproduction period can be different for each set of partitioned content. In the example illustrated in FIG. 4, the partitioned content C405 and the partitioned content C406 correspond to the advertisement content C201, while the partitioned content C411 and the partitioned content C412 correspond to the advertisement content C202. The remaining sets of partitioned content correspond to the main content C10. The sets of partitioned content in the advertisement reproduction ranges can be generated after the advertisement content to be inserted in the advertisement reproduction ranges is determined. The delivery server 30 stores, in a memory area (e.g., predetermined memory area, but not limited thereto), the partitioned content C401 to the partitioned content C415 as the content C2 for delivery. The storage location can be in the memory device of the delivery server 30, or can be in a memory device outside of the delivery server 30 (for example, a memory device of some other server). Alternatively, the partitioned content C401 to the partitioned content C415 can be stored in a split manner in two or more servers or two or more memory devices.

Then, the delivery server 30 generates configuration information M that contains the location information of the partitioned content C401 to the partitioned content C415 (S6). For example, the delivery server 30 obtains the location information of the sets of partitioned content generated at S5, and generates the configuration information M based on the obtained information. Each set of location information is, for example, the URL (i.e., Uniform Resource Locator) of one of the sets of partitioned content from the partitioned content C401 to the partitioned content C415. Meanwhile, the configuration information M is represented by, for example, MPD files.

In the example given above, the delivery server 30 generates the location information immediately after the generation of the partitioned content C401 to the partitioned content C415. However, the sets of partitioned content identified by the location information need not always be determined immediately after the partitioning. For example, immediately before delivering the content in response to a request from the terminal device 100 for the delivery of content based on the location information, the delivery server 30 can determine the sets of partitioned content to be delivered to the terminal device 100. As an example, the delivery server 30 can replace the sets of partitioned content, which are stored at the storage location indicated in the location information, with some other content. Alternatively, immediately before sending the location information to the terminal device 100, the delivery server 30 can determine the sets of partitioned content that would be indicated by the location information to be sent.

For example, after starting the transmission of the initial set of location information to the terminal device 100 for the purpose of reproducing the content C30 for delivery (or the main content C10), the delivery server 30 can determine the advertisement content to be inserted in the advertisement reproduction ranges of the content C30 for delivery (or the advertisement insertion points in the main content C10). Then, at the arrival of the timing for sending the location information meant for reproduction in the advertisement reproduction ranges, the delivery server 30 can send the location information meant for reproduction as the determined advertisement content to the terminal device 100.

Moreover, immediately before sending to the terminal device 100 the location information of the sets of partitioned content related to the advertisement insertion ranges, the delivery server 30 can determine the advertisement content to be inserted in the advertisement insertion ranges. Then, the delivery server 30 can generate the sets of partitioned content of the determined advertisement content and can treat the location information of the sets of partitioned content as the location information to be sent to the terminal device 100. Since the advertisement content can be determined immediately before the delivery, it becomes extremely easy for the delivery server 30 to perform inventory management of advertisements, such as managing the reproduction count of the concerned advertisement content.

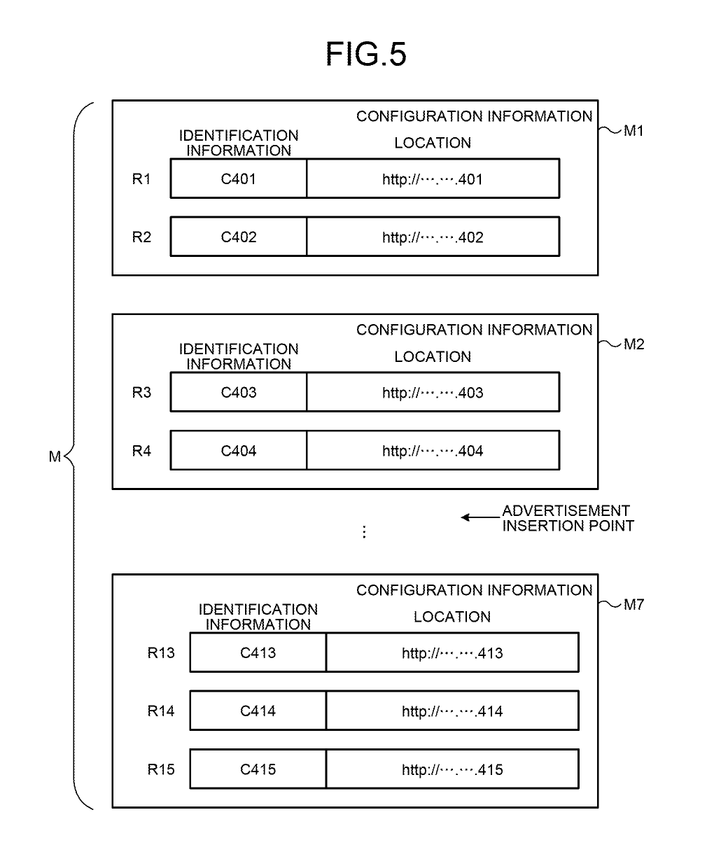

FIG. 5 is a diagram illustrating an example of the configuration information M. The configuration information M is made of a plurality of sets of configuration information. In the example illustrated in FIG. 5, the configuration information M is made of seven sets of configuration information from configuration information M1 to configuration information M7. Each set of configuration information contains a list of the locations of the sets of partitioned content. Each of a plurality of sets of configuration information constituting the configuration information M contains some sets of location information from among a plurality of sets of location information indicating the locations of the sets of partitioned content. For example, the configuration information M1 contains location information R1 having the identification information and the location (in the present example implementation, the URL) of the partitioned content C401 stored therein; and contains location information R2 having the identification information and the location of the partitioned content C402 stored therein. Moreover, the configuration information M2 contains location information R3 having the identification information and the location of the partitioned content C403 stored therein; and contains location information R4 having the identification information and the location of the partitioned content C404 stored therein. In the present example implementation, an advertisement insertion point is present after the location information R4. The configuration information M7 contains location information R13 having the identification information and the location of the partitioned content C413 stored therein; contains location information R14 having the identification information and the location of the partitioned content C414 stored therein; and contains location information R15 having the identification information and the location of the partitioned content C415 stored therein. Meanwhile, the format of the location information can be modified in an arbitrary or non-arbitrary manner. For example, the URL of a set of partitioned content itself can be treated as the location information. Furthermore, the configuration information can also contain information other than the location information. For example, the configuration information can contain information such as the reproduction period, the bitrate, the compression ratio, and the file format of the content C2.

Moreover, the configuration information can contain, in an overlapping manner, the location information included in other sets of configuration information. For example, the configuration information M2 can contain the location information R3 and the location information R4 along with the location information R2 that is included in the configuration information M1. In that case, the location information R2 gets sent twice to the terminal device 100.

When the generation of the configuration information M is completed, the delivery server 30 sends the configuration information M to the terminal device 100. The terminal device 100 obtains the sets of partitioned content based on the location information specified in the configuration information M and reproduces the sets of partitioned content (S7). At that time, instead of sending all sets of location information at once, the delivery server 30 sequentially sends some of the sets of partial information at timings (e.g., predetermined timings). For example, the delivery server 30 sequentially sends the configuration information M1 to the configuration information M7, which constitute the configuration information M, at time intervals (e.g., predetermined time intervals). Explained below specifically with reference to FIG. 5 is the operation of reproducing the content C2 as performed by the delivery server 30 and the terminal device 100.

Firstly, the delivery server 30 sends the configuration information M1. Upon receiving the configuration information M1, the terminal device 100 obtains the sets of partitioned content based on the location information specified in the configuration information M1. For example, the terminal device 100 obtains the partitioned content C401 from the URL identified by the location information R1. Moreover, the terminal device 100 obtains the partitioned content C402 from the URL identified by the location information R2.

When a period of time (e.g., predetermined period of time) elapses since the transmission of the configuration information M1, the delivery server 30 sends the configuration information M2. For example, the delivery server 30 sends the configuration information M2 at a timing that is earlier by a period of time (e.g., predetermined period of time) than the completion of the reproduction of the partitioned content C402 in the terminal device 100. Herein, the delivery server 30 can obtain the current reproduction position information from the terminal device 100, and can determine the timing of sending the configuration information to the terminal device 100 based on the reproduction position information. Of course, the delivery server 30 can send the configuration information at time intervals (e.g., predetermined time intervals). Upon receiving the configuration information M2, the terminal device 100 obtains the partitioned content C403 and the partitioned content C404 based on the location information R3 and the location information R4, respectively, specified in the configuration information M2. Herein, the terminal device 100 obtains the partitioned content C403 and the partitioned content C404 from the URLs identified by the location information R3 and the location information R4, respectively.

Moreover, the delivery server 30 sends the next configuration information at a timing that is earlier by a period of time (e.g., predetermined period of time) than the completion of the reproduction of the partitioned content identified by the current configuration information. The delivery server 30 sends the sets of configuration information in a sequential manner, and eventually sends the configuration information M7.

1-3. Operations of Delivery System at Time of Skipping

There are times when the user performs a skipping operation (also called “a seeking operation”) in the midway of video reproduction. In that case, if the user performs an operation for reproducing from a reproduction position that is after particular advertisement content by skipping that advertisement content, then the skipped advertisement content does not get viewed by the user. In that regard, the delivery server 30 sends the location information (the configuration information) in such a way that the advertisement content gets viewed by the user. Given below is the explanation of the operations performed in the delivery system 1 in response to an instance of skipping. In the following explanation, the term “skipping” can be replaced with “seeking” (for example, a seeking operation using a seek bar).

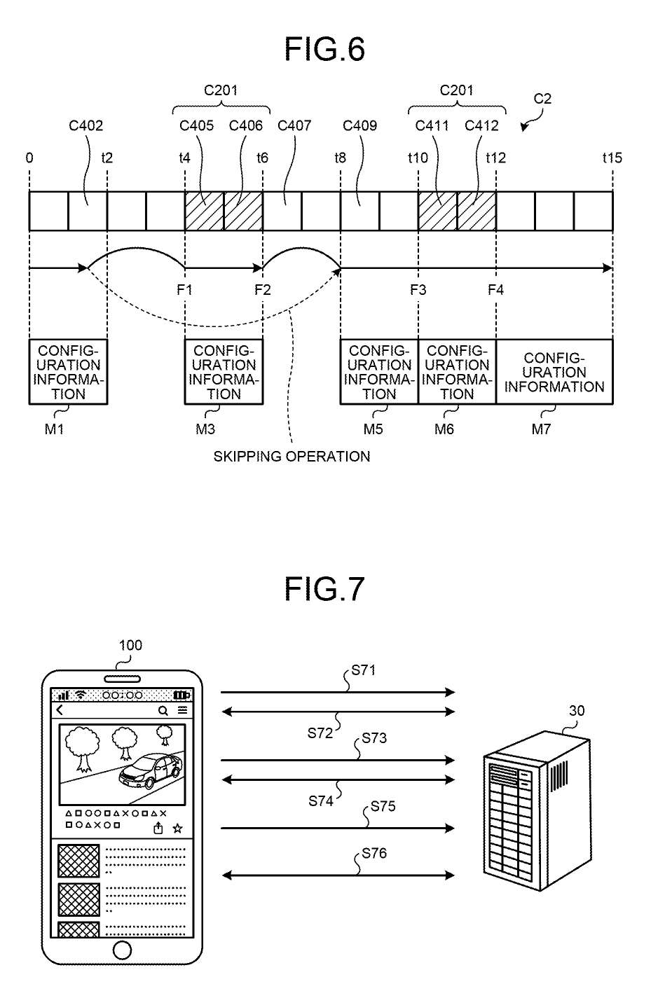

FIG. 6 is a diagram illustrating the sequence in which the configuration information is sent in response to skipping of the content C2 in the midway. FIG. 7 is a diagram illustrating the manner in which information is communicated between the delivery server 30 and the terminal device 100.

Firstly, when the user operates the terminal device 100 and accesses the delivery server 30, the terminal device 100 receives the delivery of the content C1 from the delivery server 30. Then, the terminal device 100 displays the content C1 on the screen. Moreover, upon receiving the delivery of the content C1, according to control information that was received along with the content C1, the terminal device 100 sends a delivery request to the delivery server 30 for requesting the delivery of the content C2 (S71).

Subsequently, the delivery server 30 generates the configuration information M1 to the configuration information M7 containing the locations of the partitioned content C401 to the partitioned content C415, and sends the configuration information M1 to the terminal device 100. Based on the location information R1 and the location information R2 specified in the configuration information M1, the terminal device 100 obtains the partitioned content C401 and the partitioned content C402 from the delivery server 30 and reproduces the partitioned content (S72).

Herein, assume that the user operates the terminal device 100 and performs a skipping operation (e.g., predetermined skipping operation) (also called a seeking operation). In that case, the terminal device 100 requests the delivery server 30 for the location information of the partitioned content to be skipped (S73). Upon receiving the request, the delivery server 30 sends the concerned configuration information to the terminal device 100 (S74).

At that time, assume that the delivery server 30 receives a request from the terminal device 100 for the information meant for reproducing from a reproduction position that is after particular advertisement content by skipping that advertisement content. In that case, instead of sending the location information of the partitioned content at the reproduction position as requested by the terminal device 100, the delivery server 30 sends to the terminal device 100 the location information meant for reproducing the advertisement content being planned to be skipped.

The detailed explanation is given with reference to FIG. 6. For example, assume that the delivery server 30 receives a request for the configuration information that, during the reproduction of the partitioned content C402, is meant for reproducing from a reproduction position t8 by skipping the advertisement content C201 (the partitioned content C405 and the partitioned content C406). More particularly, assume that, before sending to the terminal device 100 the configuration information M3 containing the location information meant for reproducing the advertisement content C201, the delivery server 30 receives a request from the terminal device 100 for the configuration information M5 meant for reproducing from the reproduction position t8 that is after the advertisement content C201. At that time, before sending the configuration information M5, the delivery server 30 sends the configuration information M3 containing the partitioned content C405 and the partitioned content C406. Based on the location information specified in the configuration information M3, the terminal device 100 obtains and reproduces the partitioned content C405 and the partitioned content C406.

Meanwhile, there are times when a single set of advertisement content is stored in a partitioned manner as a plurality of sets of configuration information. In that case, before sending to the terminal device 100 the location information of the partitioned content that includes the end of the advertisement content C201, if there is a request from the terminal device 100 for the information meant for reproducing from a reproduction position that is after the end of the advertisement content, then the delivery server 30 can send to the terminal device 100 the location information starting from the location information of the partitioned content including the start of the advertisement content. More particularly, before sending to the terminal device 100 the location information of the partitioned content C406 that includes the end of the advertisement content C201 (the reproduction position t6 illustrated in FIG. 6), if the configuration information meant for reproducing from the reproduction position t8 that is after the advertisement content C201 is requested by the terminal device 100, then the delivery server 30 can send to the terminal device 100 the location information starting from the location information of the partitioned content C405 that includes the beginning of the advertisement content C201 (the reproduction position t4 illustrated in FIG. 6). As a result, for example, even if a skipping operation (a seeking operation) is performed during the reproduction of particular advertisement content, it becomes possible to get the user to view that advertisement content till the end.

After the advertisement content is reproduced, the terminal device 100 sends information indicating that the advertisement content has been reproduced (hereinafter, called an advertisement reproduction notification) to the delivery server 30 (S75). The terminal device 100 can send the advertisement reproduction notification either at the timing of the start of reproduction of the advertisement content or at the timing of the end of reproduction of the advertisement content. In the case of the advertisement content C201 illustrated in FIG. 6, the terminal device 100 can send the advertisement reproduction notification either at a timing F1 or at a timing F2 illustrated in FIG. 6. Upon receiving the advertisement reproduction notification, the delivery server 30 can record the information indicating that the advertisement content has been reproduced. As a result, it becomes easy to track whether or not particular advertisement content was reproduced and to calculate the CTR (i.e., Click Through Rate). Moreover, the delivery server 30 becomes able to get to know that the configuration information subsequent to the configuration information containing an advertisement video was requested for and that the advertisement video was viewed at the timing of its delivery.

Meanwhile, instead of the timing at which the advertisement reproduction notification is received, when the location information meant for reproducing the advertisement content is sent, the delivery server 30 can record the information indicating that the advertisement content has been reproduced. For example, when the configuration information M3 containing the location information meant for reproducing the advertisement content C201 is sent to the terminal device 100, the delivery server 30 can record in a memory unit the information indicating that the advertisement content C201 has be reproduced. As a result, regardless of whether an advertisement reproduction notification is received, the delivery server 30 can track whether or not particular advertisement content was reproduced and can calculate the CTR.

Subsequently, when a period of time elapses after the partitioned content is completely reproduced, the delivery server 30 sends to the terminal device 100 the location information (the configuration information) meant for reproducing from the requested reproduction position. For example, the delivery server 30 sends to the terminal device 100 the configuration information M5 meant for reproducing from the reproduction position t8. Based on the location information specified in the configuration information, the terminal device 100 obtains the partitioned content from the delivery server 30 and reproduces it (S76). Subsequently, at a timing that is earlier by a period of time (e.g., predetermined period of time) than the completion of the reproduction of the partitioned content identified using the configuration information M5, the delivery server 30 sends the next set of configuration information. The delivery server 30 sends the sets of configuration information in a sequential manner, and eventually sends the configuration information M7.

Meanwhile, after the location information meant for reproducing the advertisement content is sent to the terminal device 100, if the timing for sending the location information meant for reproducing the same advertisement content arrives again, then the delivery server 30 does not send the location information meant for reproducing the advertisement content to the terminal device 100, but sends to the terminal device 100 the location information of the partitioned content including the reproduction position that is immediately after the concerned advertisement content. For example, after sending to the terminal device 100 the location information meant for reproducing the advertisement content C201, if the timing for sending the location information meant for reproducing the advertisement content C201 (i.e., the reproduction position t4) arrives again, then the delivery server 30 does not send the location information meant for reproducing the advertisement content C201 (the partitioned content C405 and the partitioned content C406) to the terminal device 100, but sends to the terminal device 100 the location information of the partitioned content C407 including the reproduction position t6 that is immediately after the advertisement content C201. Meanwhile, the location information can be stored in configuration information, and the configuration information can be sent.

After sending the location information meant for reproducing the advertisement content to the terminal device 100, if the timing for sending the location information meant for reproducing the same advertisement content arrives again, then the delivery server 30 can send the location information related to some different advertisement content than the concerned advertisement content. For example, after sending to the terminal device 100 the location information meant for reproducing the advertisement content C201, if the timing for sending the location information meant for reproducing the advertisement content C201 (i.e., the reproduction position t4) arrives again, then the delivery server 30 can send the location information related to the advertisement content C203 that is different than the advertisement content C201. Meanwhile, the location information can be stored in configuration information, and the configuration information can be sent.

In the conventional technology, since all sets of location information are sent at once, the advertisement content needs to be inserted in advance. As a result, the advertisement content can be skipped at will in the terminal device 100. However, according to the present example implementation, instead of sending all sets of location information at once to the terminal device 100, the delivery server 30 sequentially sends some sets of location information at timings (e.g., predetermined timings). Hence, the delivery server 30 can ensure that the terminal device 100 does not have any free control on the reproduction of the content C30 for delivery. As a result, the delivery server 30 can get the user to view the advertisement content inserted in the content C30 for delivery.

Moreover, according to the present example implementation, when there is a request from the terminal device 100 for the information meant for reproducing from a reproduction position that is after particular advertisement content by skipping the advertisement content, the delivery server 30 sends to the terminal device 100 the location information meant for reproducing the advertisement content. Hence, the delivery server 30 can get the user to view the advertisement content. Furthermore, since the delivery server 30 can get to know whether or not the advertisement content was viewed, it becomes easier for the operator of the delivery server 30 to perform inventory management of advertisements. Moreover, the advertisement content not reproduced often (i.e., the advertisement content having a large inventory) can be assigned in the content C30 for delivery, thereby making it extremely easy to perform inventory management of advertisements.

### 2. EXAMPLE CONFIGURATION OF DELIVERY SYSTEM

Till now, the operations of the information processing device according to the present example implementation are explained with reference to the example of the delivery system 1 that includes the delivery server 30 representing an example of the information processing device. Given below is the explanation of a configuration of the information processing device according to the present example implementation. In the following explanation, a configuration of the information processing device is explained with reference to the example of the delivery system 1. As described earlier, the delivery system 1 includes the content owner server 10, the advertisement owner server 20, the delivery server 30, and the terminal device 100. The content owner server 10, the advertisement owner server 20, the delivery server 30, and the terminal device 100 are connected to each other via a network N. The network N is a communication network such as a LAN (i.e., Local Area Network), a WAN (i.e., Wide Area Network), a telephone network, an area IP network (IP stands for Internet Protocol), and the Internet. The network N can be a wired network or can be a wireless network. Meanwhile, in the delivery system 1, each of the content owner server 10, the advertisement owner server 20, the delivery server 30, and the terminal device 100 can be installed in plurality.

The content owner server 10 is a server device used by the content owner. The content owner server 10 can be a PC server, a midrange server, or a mainframe server. The content owner server 10 follows instructions of the content owner and submits the main content to the delivery server 30. In the present example implementation, the main content submitted by the content owner server 10 represents videos.

The advertisement owner server 20 is a server device used by the advertisement owner. The advertisement owner server 20 can be a PC server, a midrange server, or a mainframe server. The advertisement owner server 20 follows instructions of the advertisement owner and submits the advertisement content to the delivery server 30. In the present example implementation, the advertisement content submitted by the advertisement owner server 20 represents videos. There are times when the advertisement owner requests an agency to submit the advertisement content. In that case, the agency submits the advertisement content to the delivery server 30. In the following explanation, the term “advertisement owner” not only implies the original advertisement owner but also covers an agency. Moreover, the term “advertisement owner server” not only implies the advertisement owner server 20 but also covers an agency server used by an agency.

### 3. EXAMPLE CONFIGURATION OF DELIVERY SERVER

Given below is the explanation of a configuration of the delivery server 30. The delivery server 30 is host computer for servers (hereinafter, called a “server”) that processes requests received from client terminals such as the terminal device 100. The delivery server 30 can be a PC server, a midrange server, or a mainframe server. Moreover, the delivery server 30 can be configured using a single server, or can be configured using a plurality of servers performing operations in tandem. When the delivery server 30 is configured using a plurality of servers, the installation locations of the servers can be distant locations. Even if the installation locations are distant locations, as long the operations are performed in tandem, the servers can be considered as a single advertisement delivery server.

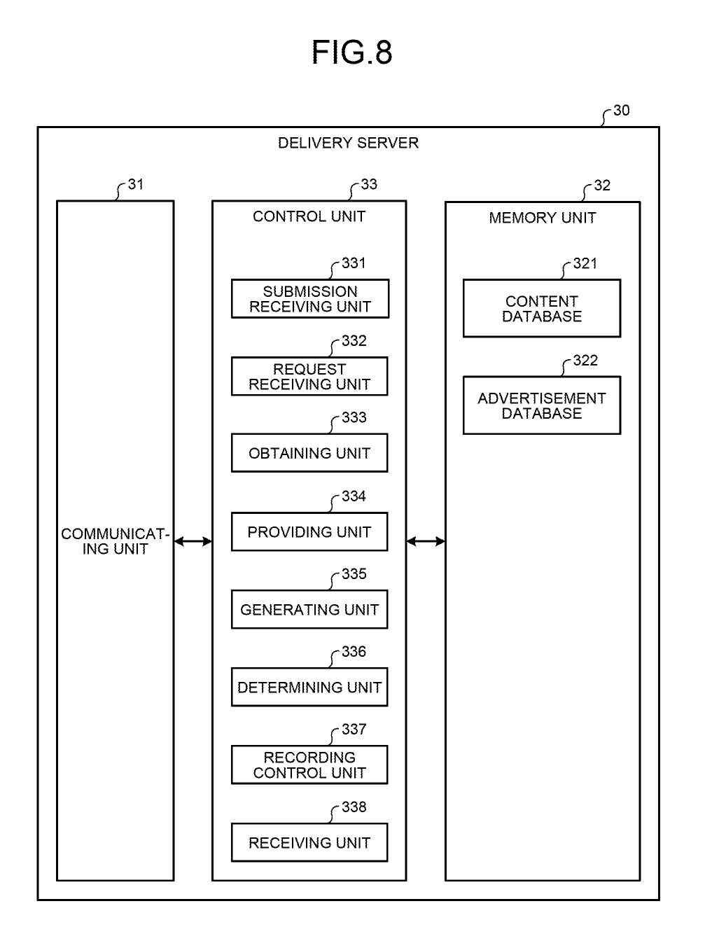

FIG. 8 is a diagram illustrating an example configuration of the delivery server 30 according to the example implementation. The delivery server 30 includes a communicating unit 31, a memory unit 32, and a control unit 33. The configuration illustrated in FIG. 8 is a functional configuration, and the hardware configuration can be different than that.

The communicating unit 31 is a communication interface enabling communication with external devices. The communicating unit 31 can be a network interface or can be a device connection interface. For example, the communicating unit 31 can be a LAN interface such as an NIC (i.e., Network Interface Card), or can be a USB interface (USB stands for Universal Serial Bus) configured using a USB host controller and a USB port. Moreover, the communicating unit 31 can be a wired interface or can be a wireless interface. The communicating unit 31 functions as the communication device of the delivery server 30. The communicating unit 31 permits the delivery server 30 to perform communication with the terminal device 100 under the control of the control unit 33.

The memory unit 32 is a memory medium such as a DRAM (i.e., Dynamic Random Access Memory), an SRAM (i.e., Static Random Access Memory), a flash memory, or a hard disk with respect to which data reading and data writing can be performed. The memory unit 32 functions as a memory device of the delivery server 30. The memory unit 32 is used to store a content database 321 and an advertisement database 322.

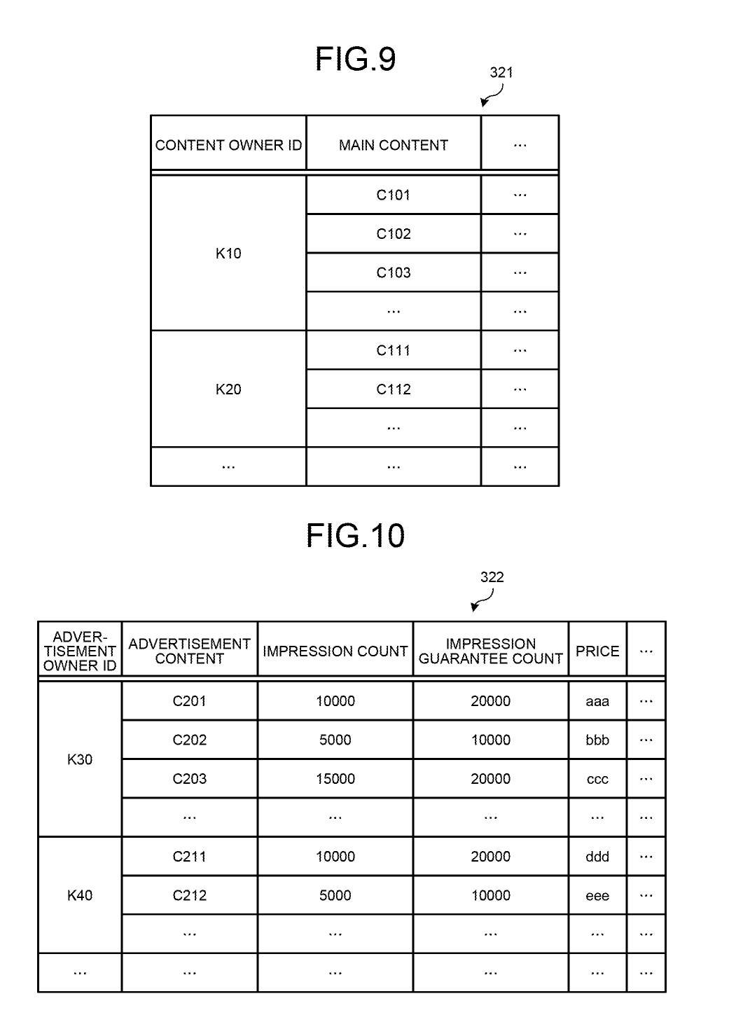

The content database 321 is used to store a variety of information related to the main content submitted from the content owner server 10. FIG. 9 is a diagram illustrating an example of the information stored in the content database 321 according to the example implementation. In the example illustrated in FIG. 9, the content database 321 includes the following items: “content owner ID” and “main content”.

The item “content owner ID” represents identification information enabling identification of the content owner or the content owner server 10. In the example illustrated in FIG. 9, although the item “content owner ID” has conceptual information such as “K10” and “K20” stored therein, an identification number indicating the content owner or the content owner server 10 can also be stored therein. The item “main content” indicates the main content submitted from the content owner server 10. In the example illustrated in FIG. 9, although the item “main content” has conceptual information such as “C101” to “C112” stored therein, the data of the content (for example, video data) can also be stored therein. Of course, the item “main content” can have the URLs (i.e., Uniform Resource Locators) of the content stored therein or can have the file path names indicating the storage locations of the content stored therein.

Meanwhile, in the content database 321, a display instruction regarding the content C2 can also be stored. A display instruction can include the placement position of the content C2 and the setting value of the display area A. For example, a display instruction can include information indicating the position and the size of the display area A with reference to the upper end of the content C1. Moreover, a display instruction can include information indicating the insertion position (time) for inserting the advertisement content in the main content for delivery. Furthermore, a display instruction can include information indicating the operation of the user or the state of the terminal device 100 that serves as a trigger for moving on to the next webpage. The setting of the display instruction can be done by, for example, the content owner at the time of registering the main content.

The advertisement database 322 is used to store a variety of information related to the advertisement content submitted from the advertisement owner server 20. FIG. 10 is a diagram illustrating an example of the information stored in the advertisement database 322 according to the example implementation. In the example illustrated in FIG. 10, the advertisement database 322 includes the following items: “advertisement owner ID”, “advertisement content”, “impression count”, “impression guarantee count”, and “price”.

The item “advertisement ID” indicates the identification information enabling identification of the advertisement owner or the advertisement owner server 20. The “advertisement content” indicates the content submitted from the advertisement owner server 20, that is, the content related to advertisements such as the advertisement content C20. In the example illustrated in FIG. 10, although the “advertisement content” has conceptual information such as “C201” to “C212” stored therein, the data of the content (for example, video data) can also be stored therein. Of course, the “advertisement content” can have the URLs of the content stored therein or can have the file path names indicating the storage locations of the content stored therein.

The “impression count” indicates the number of times for which particular advertisement content is displayed. The “impression guarantee count” indicates the guaranteed display count of particular advertisement content against the price. The “price” indicates the remuneration paid from the advertisement owner when particular advertisement content is displayed for the count equal to the “impression guarantee count”. Thus, the delivery server 30 represents the server that delivers the content related to advertisements in the impression guaranteed manner.

That is, in the example illustrated in FIG. 10, the advertisement owner identified by the advertisement owner ID “K30” submits the content “C201”, the content “C202”, and the content “C203” as the sets of advertisement content. In the example illustrated in FIG. 10, the advertisement content “C201” has the impression count of “1000”, has the impression guarantee count of “20000”, and has the price (charge) of “aaa” when the content “C201” is displayed for the count equal to the impression guarantee count. Herein, the delivery server 30 can count the impression count for each of a plurality of sets of content (a plurality of sets of advertisement content) arranged in a single webpage, or can count the impression count by treating a plurality of sets of content (a plurality of sets of advertisement content) in a single webpage as a single advertisement.

Meanwhile, if the delivery server 30 delivers pay-per-click type advertisements, then the advertisement database 322 is used to store the content selection count and the charge at the time of selection of the content. A pay-per-click type advertisement is an advertisement for which the charging is done every time that advertisement is selected. Alternatively, if the delivery server 30 delivers tender-type advertisements, then the advertisement database 322 is used to store the tender price representing the advertisement fees set by the advertiser as the remuneration per impression, or is used to store the CTR (i.e., Click Through Rate). A tender-type advertisement implies an advertisement for which the advertisement content is selected by tendering bids when the delivery server 30 receives a delivery request.

Meanwhile, the advertisement database 322 can be used to store the information other than the items described above. For example, the advertisement database 322 can be used to further store information for performing matching of the content and the user, or information such as the CTR. Moreover, the advertisement database 322 can be used to store display instructions meant for instructing changes in the display form of the advertisement content. A display instruction can include the placement position of the content C40 and the setting value of the display area A. For example, a display instruction can include information indicating the position and the size of the display area A with reference to the upper end of the content C1. Moreover, a display instruction can include information on the insertion position (timing) for inserting the advertisement content in the main content for delivery. Furthermore, a display instruction can include information indicating the operation of the user that serves as a trigger for moving on to the next webpage, and information indicating the state of the terminal device 100. The setting of the display instruction can be done by, for example, the advertisement owner at the time of registering the advertisement content.

Returning to the explanation with reference to FIG. 8, the control unit 33 is a controller implemented when, for example, a processor such as a CPU (i.e., Central Processing Unit) or an MPU (i.e., Micro Processing Unit) executes various computer programs (e.g., non-transitory computer readable medium including stored instructions executed by a microprocessor), which are stored in an internal memory device of the delivery server 30, while using a RAM (i.e., Random Access Memory) as the work area. Alternatively, the control unit 33 can be a controller implemented using, for example, an integrated circuit such as an ASIC (i.e., Application Specific Integrated Circuit) or an FPGA (i.e., Field Programmable Gate Array).

As illustrated in FIG. 8, the control unit 33 includes a submission receiving unit 331, a request receiving unit 332, an obtaining unit 333, a providing unit 334, a generating unit 335, a determining unit 336, a recording control unit 337, and a receiving unit 338. Each block constituting the control unit 33 (i.e., each of the submission receiving unit 331 to the receiving unit 338) represents a functional block of a function of the control unit 33. These functional blocks either can be software blocks or can be hardware blocks. For example, each functional block can be a single software module implemented using software (including microprograms), or can be a single circuit block on a semiconductor chip (die). Of course, each functional block can be a single processor or a single integrated circuit. The method for configuring the functional blocks can be any method (e.g., arbitrary). Meanwhile, the control unit 33 can alternatively be configured with functional units that are different than the functional blocks described above.

The submission receiving unit 331 receives submission of the main content from the content owner server 10. Moreover, the submission receiving unit 331 receives a display instruction regarding the main content. In that case, the submission receiving unit 331 registers the main content and the display instruction along with the content owner ID in the content database 321.

Furthermore, the submission receiving unit 331 receives submission of the advertisement content from the advertisement owner server 20. More particularly, the submission receiving unit 331 receives submission of the advertisement content along with the specification of the price. Moreover, the submission receiving unit 331 receives a display instruction regarding the advertisement content. In that case, the submission receiving unit 331 registers the advertisement content and the display instruction along with the advertisement owner ID and the price in the advertisement database 322.

The request receiving unit 332 receives an obtaining request from the terminal device 100 for obtaining the content. For example, the request receiving unit 332 receives an obtaining request regarding the content C1 and the content C2. For example, as an obtaining request regarding the content C1, the request receiving unit 332 receives an obtaining request regarding webpage data or application data. Moreover, as an obtaining request regarding the content C2, the request receiving unit 332 receives an obtaining request regarding video data and application data. At that time, as an obtaining request regarding the sets of content C1 and C2, the request receiving unit 332 can receive an HTTP request (HTTP stands for Hyper Text Transfer Protocol).

The obtaining unit 333 obtains a plurality of sets of location information, each indicating the location of first-type content that includes at least either videos or sounds and that includes second-type content within a reproduction range (e.g., predetermined reproduction range). For example, the obtaining unit 333 obtains the location information of each of a plurality of sets of partitioned content obtained by partitioning first-type content that includes at least either videos or sounds and that includes second-type content within a reproduction range (e.g., predetermined reproduction range).

When the request receiving unit 332 receives an obtaining request regarding the content, the providing unit 334 sends (e.g., provides) the information about the content to the terminal device 100. For example, to the terminal device 100 that reproduces the first-type content based on the location information, the providing unit 334 sequentially sends some of the sets of the location information at timings (e.g., predetermined timings). The information sent by the providing unit 334 can contain control information too.

The control information can be a computer program (e.g., non-transitory computer readable medium including stored instructions executed by a microprocessor) written in a script language such as JavaScript (registered trademark). Of course, the control information can be information written in a computer language other than a script language. For example, the control information can be information written in a markup language such as HTML or XML (i.e., Extensible Markup Language), or can be information written in a stylesheet language such as CSS (i.e., Cascading Style Sheets) or CSS3. Alternatively, the control information can be a computer program (e.g., non-transitory computer readable medium including stored instructions executed by a microprocessor, such as an application) that is written and compiled in a programming language such as Java (registered trademark), Swift, C, and C++. Meanwhile, as long as the terminal device 100 is able to eventually execute a computer program (e.g., non-transitory computer readable medium including stored instructions executed by a microprocessor), the control information need not be a compiled computer program. Other than that, the control information can be data (a computer program) provided in the format of an interpretive language (for example, a script language), a machine language, or an intermediate language.

The control information can also contain information about display instructions regarding the content. For example, a display instruction can include the placement position of the content and the setting value of the display area A. For example, a display instruction can include information indicating the position and the size of the display area A with reference to the upper end of the content C1. Moreover, the display instruction can include information indicating the insertion position (time) for inserting the second-type content in the first-type content. Furthermore, a display instruction can include information indicating the operation of the user or the state of the terminal device 100 that serves as a trigger for moving on to the next webpage.

Moreover, when there is a request from the terminal device 100 for the information meant for reproducing from a reproduction position that is after particular second-type content by skipping that second-type content, the providing unit 334 sends the location information meant for reproducing the second-type content to the terminal device 100.

Furthermore, when there is a request from the terminal device 100 for the information meant for reproducing from a reproduction position that is after particular second-type content by skipping that second-type content, the providing unit 334 sends the location information meant for reproducing the second-type content to the terminal device 100, and then sends the location information meant for reproducing from the requested reproduction position to the terminal device 100.

Moreover, before sending the location information meant for reproducing the second-type content to the terminal device 100, when there is a request from the terminal device 100 for information meant for reproducing from a reproduction position that is after the second-type content, the providing unit 334 sends the location information meant for reproducing the second-type content to the terminal device 100.

Furthermore, before sending the location information meant for reproducing the end of the second-type content (for example, the location information of the partitioned content that includes the end of the second-type content) to the terminal device 100, when there is a request from the terminal device 100 for information meant for reproducing from a reproduction position that is after the end of the second-type content, the providing unit 334 sends to the terminal device 100 the location information starting from the location information meant for reproducing the start of the second-type content (for example, starting from the location information of the partitioned content that includes the beginning of the second-type content).

Moreover, after the location information meant for reproducing the second-type content is sent to the terminal device 100, if the timing for sending the location information meant for reproducing the second-type content arrives again, the providing unit 334 does not send the location information meant for reproducing the second-type content to the terminal device 100, but sends to the terminal device 100 the location information meant for reproducing from the reproduction position that is immediately after the second-type content (i.e., the location information of the partitioned content including the reproduction position that is immediately after the second-type content).

Furthermore, after the location information meant for reproducing the second-type content is sent to the terminal device 100, if the timing for sending the location information meant for reproducing the second-type content arrives again, the providing unit 334 sends the location information related to third-type content that is different than the second-type content.

Moreover, before the information indicating that the second-type content has been reproduced is received from the terminal device 100, if there is a request from the terminal device 100 for the information meant for reproducing from a reproduction position that is after the second-type content, then the providing unit 334 sends the location information meant for reproducing the second-type content to the terminal device 100.

Furthermore, after the information indicating that the second-type content has been reproduced is received from the terminal device 100, if the timing for sending the location information meant for reproducing the second-type content arrives again, the providing unit 334 does not send the location information meant for reproducing the second-type content, but sends to the terminal device 100 the location information meant for reproducing from the reproduction position that is immediately after the second-type content (for example, the location information of the partial content including the reproduction position that is immediately after the second-type content).

Moreover, after the information indicating that the second-type content has been reproduced is received from the terminal device 100, if the timing for sending the location information meant for reproducing the second-type content arrives again, then the providing unit 334 sends the location information related to the third-type content that is different than the second-type content.

Furthermore, when the timing for sending the location information meant for reproducing a reproduction range (e.g., predetermined reproduction range) arrives; the providing unit 334 sends, to the terminal device 100 as the location information meant for reproducing the second-type content, the location information meant for reproducing the content determined by the determining unit 336.

Moreover, when the information meant for reproducing a reproduction range (e.g., predetermined reproduction range) is received from the terminal device 100; after the determining unit 336 determines the content to be treated as the second-type content, the providing unit 334 sends to the terminal device 100 the location information meant for reproducing the second-type content determined by the determining unit 336.

Furthermore, to the terminal device 100 that reproduces the first-type content based on the configuration information, the providing unit 334 sends the configuration information in a sequential manner at timings (e.g., predetermined timings). Moreover, when there is a request from the terminal device 100 for the information meant for reproducing from a reproduction position that is after particular second-type content by skipping the second-type content, the providing unit 334 sends the location information meant for reproducing the second-type content to the terminal device 100.

The generating unit 335 generates a plurality of sets of configuration information, each containing some sets of location information from among a plurality of sets of location information of a plurality of sets of partitioned content obtained by partitioning the first-type content that includes at least either videos or sounds and that includes the second-type content in a range (e.g., predetermined range).

The determining unit 336 determines the reproduction position of the second-type content. Moreover, the determining unit 336 determines the second-type content that is to be delivered upon receiving a request from the terminal device 100 for the location information including the second-type content.

After the transmission of the initial location information meant for reproducing the first-type content is started, the determining unit 336 determines the content to be treated as the second-type content. After there is a request from the terminal device 100 for the information meant for reproducing a reproduction range (e.g., predetermined reproduction range), the determining unit 336 can determine the content to be treated as the second-type content.

The recording control unit 337 records the information indicating the reproduction of the second-type content when the location information meant for reproducing the second-type content is sent.

The receiving unit 338 receives, from the terminal device 100, the information indicating that the second-type content has been reproduced.

### 4. EXAMPLE CONFIGURATION OF TERMINAL DEVICE

Given below is the explanation of a configuration of the terminal device 100. The terminal device 100 is an information display device that is used by the user for viewing the content (for example, application screens and webpages). Examples of the terminal device 100 include communication terminals such as a smartphone, a tablet, and a cellular phone. Alternatively, as long as the communication function is provided, the terminal device 100 can be an information processing terminal such as a personal computer (e.g., a laptop PC or a desktop PC) or a PDA (i.e., Personal Digital Assistant). In that case, the information processing terminal too represents a type of a communication terminal. The terminal device 100 is connected to the delivery server 30 via the network N.

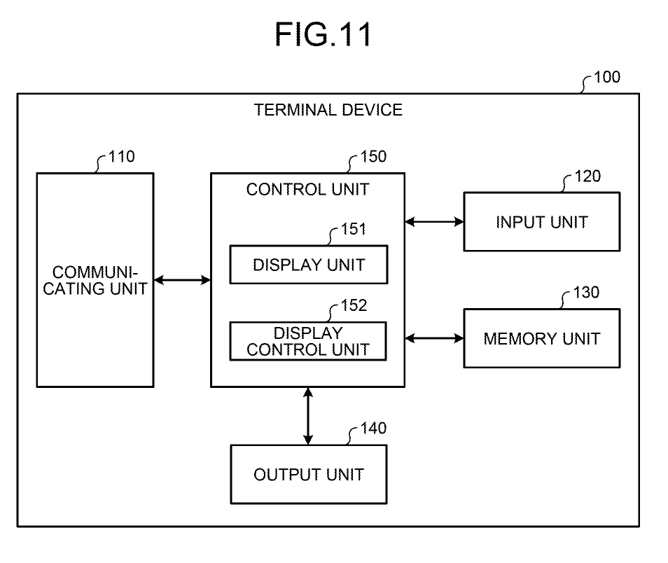

FIG. 11 is a diagram illustrating an example configuration of the terminal device 100 according to the example implementation. The terminal device 100 includes a communicating unit 110, an input unit 120, a memory unit 130, an output unit 140, and a control unit 150. The configuration illustrated in FIG. 11 is a functional configuration, and the hardware configuration can be different than that.

The communicating unit 110 is a communication interface enabling communication with external devices. The communicating unit 110 can be a network interface or can be a device connection interface. For example, the communicating unit 110 can be a LAN interface such as an NIC, or can be a USB interface configured using a USB host controller and a USB port. Moreover, the communicating unit 110 can be a wired interface or can be a wireless interface. The communicating unit 110 functions as the communication device of the terminal device 100. The communicating unit 110 performs communication with the delivery server 30 under the control of the control unit 150.

The input unit 120 is an input device that receives a variety of input from outside. Moreover, for example, the input unit 120 is an operating device such as a keyboard, a mouse, or operation keys used by the user to perform various operations. The input unit 120 functions as an input device of the terminal device 100. When a touch-sensitive panel is used in the terminal device 100, the touch-sensitive panel too is included in the input unit 120. In that case, the user performs various operations by touching the screen using a finger or a stylus pen.

The memory unit 130 is a memory device such as a DRAM, an SRAM, a flash memory, or a hard disk with respect to which data reading and data writing can be performed. The memory unit 130 functions as a memory device of the terminal device 100. The memory unit 130 is used to store the data of applications. The data of applications can be the data of the web browser. In the following explanation, a web browser is referred to as a browser.

The output unit 140 performs a variety of output such as sound, light, vibrations, and images to the outside. The output unit 140 functions as the output device of the terminal device 100. The output unit 140 includes a display device for displaying a variety of information. Examples of the display device include a liquid crystal display and an organic EL (i.e., Electro Luminescence). When a touch-sensitive panel is used in the terminal device 100, the display device (hereinafter, called the screen) can be integrated with the input unit 120. The output unit 140 displays images on the screen under the control of the control unit 150.

The control unit 150 is a controller implemented when, for example, a processor such as a CPU or an MPU executes various computer programs (e.g., non-transitory computer readable medium including stored instructions executed by a microprocessor), which are stored in an internal memory device of the terminal device 100, while using a RAM as the work area. Alternatively, the control unit 150 can be a controller implemented using, for example, an integrated circuit such as an ASIC or an FPGA.

As illustrated in FIG. 11, the control unit 150 includes a display unit 151 and a display control unit 152. Each block constituting the control unit 150 (i.e., each of the display unit 151 and the display control unit 152) is a functional block of a function of the control unit 150. These functional blocks either can be software blocks or can be hardware blocks. For example, each functional block can be a single software module implemented using software (including microprograms), or can be a single circuit block on a semiconductor chip (e.g., die). Of course, each functional block can be a single processor or a single integrated circuit. The method for configuring the functional blocks can be any method (e.g., arbitrary). Meanwhile, the control unit 150 can alternatively be configured with functional units that are different than the functional blocks described above.

The display unit 151 displays the content C1 and the content C2, which is placed in the display area A of the content C1, on the screen. The content C1 can be an application screen or can be a webpage. The content C2 can be a video.

The display control unit 152 varies the display form of the content C1 and the content C2 according to the user operation. For example, the display control unit 152 scrolls the content C1 according to the user operation. Moreover, the display control unit 152 starts reproducing the content C2 according to a user operation.

### 5. OPERATION FLOW OF DELIVERY SERVER

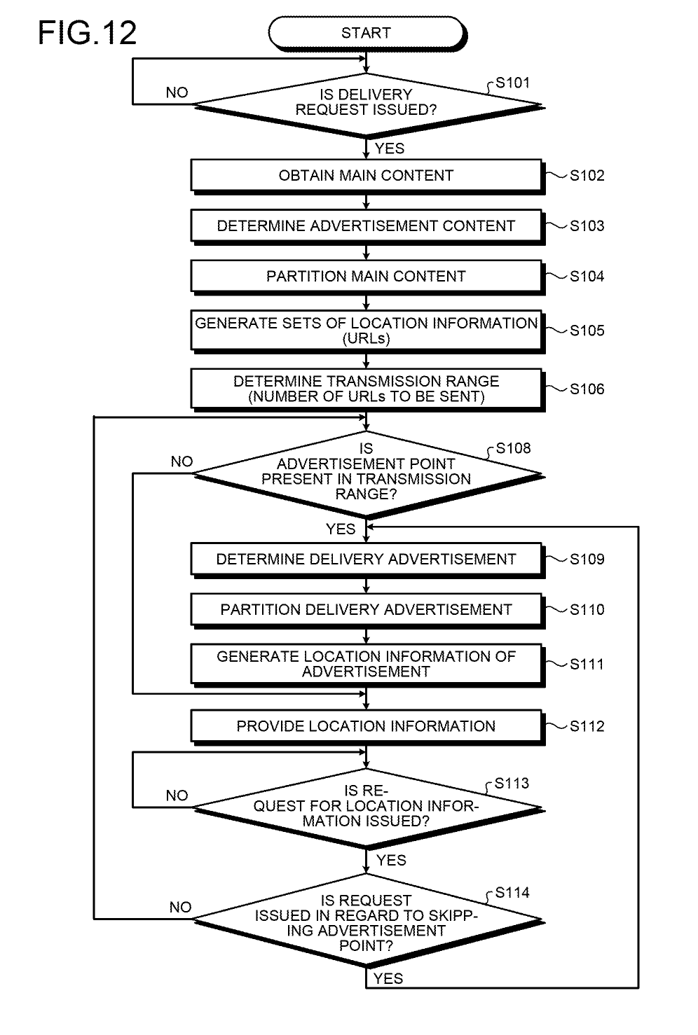

Given below is the explanation of a sequence of operations performed in the delivery server 30. FIG. 12 is a flowchart for explaining an example of the delivery operation. The flowchart explained below is only an example, and can be modified in various ways. The delivery server 30 starts the delivery operation when the power supply thereof is switched on.

Firstly, the delivery server 30 determines whether or not a delivery request regarding the content C2 is received from the terminal device (S101). If no delivery request is received (No at S101), then the delivery server 30 waits until a delivery request is received.

When a delivery request is received (Yes at S101), the delivery server 30 obtains the main content C10 from the memory unit 32 (S102). Then, the delivery server 30 determines the advertisement points (S103). The advertisement points represent the advertisement insertion points in the main content C10. In the example illustrated in FIG. 2, the two reproduction positions t4 and t8 represent the advertisement points. The main content C10 in which the advertisement points have been determined represents the content C30 for delivery. Herein, the delivery server 30 can also determine in advance the reproduction periods of the advertisements to be inserted in the main content C10. That is, as illustrated in FIG. 3, the delivery server 30 can determine in advance the advertisement reproduction ranges in the content C30 for delivery.

Once the advertisement points are determined, the delivery server 30 partitions the main content C10 (the content C30 for delivery) into a plurality of sets of partitioned content (the partitioned content C401 to the partitioned content C415) as illustrated in FIG. 4 (S104).

Then, the delivery server 30 stores the sets of partitioned content in a memory area (for example, the memory area provided in the memory unit 32) and obtains the location information (for example, the URL) of each set of partitioned content (S105). At that point of time, if the sets of advertisement content to be inserted in the advertisement reproduction ranges are not yet determined, the delivery server 30 can treat, as the location information, the planned locations for storing the partitioned content of the advertisement content at a later timing.

Then, the delivery server 30 determines the transmission range of the partitioned content (S106). For example, the delivery server 30 determines the number of sets of location information to be sent at the concerned timing (for example, determines the number of URLs to be stored in the configuration information to be sent at the concerned timing).

Subsequently, the delivery server 30 determines whether or not there is any advertisement point in the concerned transmission range (S108). If there is no advertisement point in the concerned transmission range (No at S108), then the system control proceeds to S112. On the other hand, if there is any advertisement point in the concerned transmission range (Yes at S108), the delivery server 30 determines the advertisement content (hereinafter, also called delivery advertisement) to be delivered to the terminal device 100 from the advertisement database 322 (S109). The delivery server 30 can determine the delivery advertisement content based on attribute information of the user who is operating the terminal device 100.

The attribute information of the user represents, for example, the demographic information or the psychographic information. As a specific example, the attribute information represents the following information about the user (the questioner or the answerer): the age, the occupation, the income, the assets, the address, the business address, the used language, the family structure, the relationships with friends, the lifecycle, the set of values, the lifestyle, the personality makeup, the preferences, and the changes in those attributes. Moreover, the user attribute information can also contain the search history or the service usage history of the user. Of course, the user attribute information is not limited to the information mentioned above.

Then, the delivery server 30 partitions the delivery advertisement and generates sets of partitioned content (S110). Subsequently, the delivery server 30 generates the location information of the advertisement (the sets of partitioned content) (S111).

Subsequently, the delivery server 30 sends the location information of the sets of partitioned content, which are included in the concerned transmission range, to the terminal device 100 (S112).

Then, the delivery server 30 determines whether or not there is a request from the terminal device 100 for the location information (S113). If there is no request (No at S113), then the delivery server 30 repeats the determination at S113 until there is a request.

When there is a request (Yes at S113), the delivery server 30 determines whether or not the request is issued in regard to skipping the advertisement point (S114). If the request is not issued in regard to skipping the advertisement point (No at S114), then the system control returns to S108. On the other hand, when the request is issued in regard to skipping the advertisement point (Yes at S114), the system control returns to S109 so as to display the advertisement, which was planned to be skipped, to the user.

The delivery server 30 again performs the operations from S108 to S114 until the end of reproduction of the content C30 for delivery in the terminal device 100 (for example, until the end of transmission of the location information of the last set of partitioned content of the content C30 for delivery).

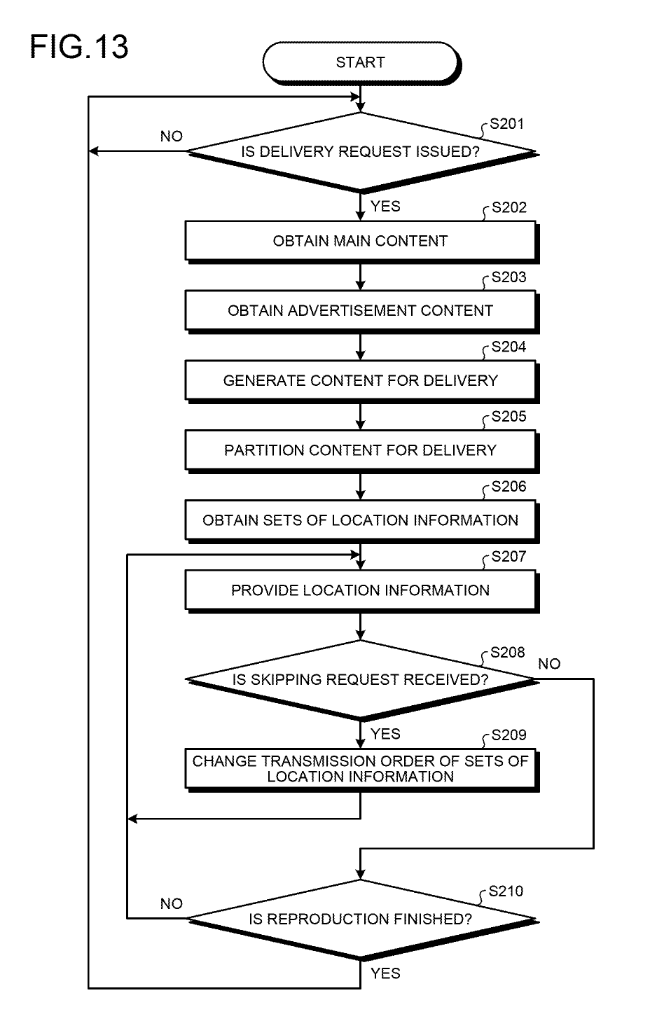

Meanwhile, the delivery operation can be written in the following manner too. FIG. 13 is a flowchart for explaining another example of the delivery operation. The delivery server 30 starts the delivery operation when the power supply thereof is switched on.

Firstly, the delivery server 30 determines whether or not a delivery request regarding the content C2 is received from the terminal device 100 (S201). If no delivery request is received (No at S201), then the system control waits until a delivery request is received.

When a delivery request is received (Yes at S201), the delivery server 30 obtains the main content C10 from the memory unit 32 (S202). Moreover, the delivery server 30 obtains the advertisement content C20 from the memory unit 32 (S203). The advertisement content C20 includes a plurality of sets of advertisement content (the advertisement content C201 and the advertisement content C202). Herein, the advertisement content C20 can be determined immediately before the delivery of the content. In that case, the delivery server 30 can obtain the advertisement content C20 after obtaining the location information at S16 (described later).

Then, the delivery server 30 inserts the advertisement content C20 in the main content C10 and generates the content C30 for delivery (S204). Subsequently, the delivery server 30 partitions the content C30 for delivery into a plurality of sets of partitioned content (the partitioned content C401 to the partitioned content C415) (S205).

Then, the delivery server 30 stores the sets of partitioned content in a memory area (for example, the memory area provided in the memory unit 32) and obtains the location information of each set of partitioned content (S206). Subsequently, the delivery server 30 sends the location information to the terminal device 100 (S207). At that time, the delivery server 30 sequentially sends a number (e.g., predetermined) of sets of location information, which are sequentially selected from a plurality of sets of location information, at timings (e.g., predetermined timings). Meanwhile, the delivery server 30 can determine the sets of partitioned content immediately before the delivery of the content. In that case, immediately before the delivery, the delivery server 30 can replace the sets of partitioned content stored at the storage locations indicated by the location information.

Subsequently, the delivery server 30 determines whether or not a skipping request is received from the terminal device 100 (S208). If a skipping request is received (Yes at S208), then the delivery server 30 performs an operation for changing the transmission order of the sets of location information (S209). For example, assume that the delivery server 30 receives a request from the terminal device 100 for the location information meant for reproducing from a reproduction position that is after the advertisement content by skipping the advertisement content. In that case, the delivery server 30 changes the transmission order of the sets of location information in such a way that the location information meant for reproducing the advertisement content is sent to the terminal device 100. After the transmission order is changed, the system control returns to S207, and the delivery server 30 sends the sets of location information according to the changed order.

On the other hand, if a skipping request is not received (No at S208), then the delivery server 30 determines whether or not the terminal device 100 has finished the reproduction of the content C2 (S210). For example, the delivery server 30 determines whether or not all sets of location information have been sent to the terminal device 100. If the reproduction of the content C2 is not finished (No at S210), then the system control returns to S207 and the delivery server 30 continues with the transmission of the location information.

When the reproduction of the content C2 is finished (Yes at S210), the system control returns to S201 and the delivery server 30 again performs the operations from S201 to S210.

### 6. MODIFICATION EXAMPLE

The example implementation described above is only an example, and can be subjected to various modifications and applications.

In the example implementation described above, before sending the location information meant for reproducing the advertisement content to the terminal device 100, if there is a request from the terminal device 100 for reproducing from a reproduction position that is after the advertisement content, the delivery server 30 sends the location information meant for reproducing the advertisement content to the terminal device 100. However, alternatively, based on whether or not information indicating that the advertisement content has been reproduced (e.g., an advertisement reproduction notification) is received, the delivery server 30 can determine whether or not to send the location information meant for reproducing the advertisement content. For example, before receiving an advertisement reproduction notification from the terminal device 100, if there is a request from the terminal device 100 for the information meant for reproducing from a reproduction position that is after the advertisement content, the delivery server 30 sends the location information meant for reproducing the advertisement content to the terminal device 100.

After an advertisement reproduction notification is received from the terminal device 100, if the timing for sending the location information meant for reproducing the same advertisement content arrives again, then the delivery server 30 need not send the location information meant for reproducing the advertisement content to the terminal device 100, but can send to the terminal device 100 the location information of the partitioned content including the reproduction position that is immediately after the concerned advertisement content.

Moreover, after an advertisement reproduction notification is received from the terminal device 100, if the timing for sending the location information meant for reproducing the same advertisement content arrives again, then the delivery server 30 can send the location information related to some other advertisement content different than the advertisement content specified in the advertisement reproduction notification. In the example illustrated in FIG. 6, after an advertisement reproduction notification is received from the terminal device 100, when the timing (the reproduction position t4) for sending the location information meant for reproducing the advertisement content C201 arrives again, the delivery server 30 can send the location information related to the advertisement content C203 that is different than the advertisement content C201. Meanwhile, the location information can be stored in configuration information, and the configuration information can be sent.

In the example implementation described above, the first-type content as well as the second-type content is understood to be video content. However, the first-type content and the second-type content need not always be video content. Alternatively, the first-type content and the second-type content can be audio content configured using music or sounds. In other words, audio content can be called music content or sound content.

In the example implementation described above, the content C1 as well as the content C2 is understood to be delivered from the delivery server 30. However, alternatively, the delivery server for delivering the content C1 can be different than the delivery server for delivering the content C2.

In the example implementation described above, the first-type content represents the main content, and the second-type content represents the advertisement content. However, alternatively, the first-type content can represent the advertisement content, and the second-type content can represent the main content. Besides, the first-type content and the second-type content are not limited to the main content and the advertisement content. That is, the first-type content as well as the second-type content can be content other than the main content and the advertisement content. Moreover, the first-type content and the second-type content are not limited to video content or audio content; and can be gaming content, for example.

The control device that controls the delivery server 30 according to the present example implementation can be implemented using a dedicated computer system or using a commonly-used computer system. For example, a computer program (e.g., non-transitory computer readable medium including stored instructions executed by a microprocessor) meant for carrying out the operations described above can be distributed by storing it in a computer-readable recording medium such as an optical disk, a semiconductor memory, a magnetic table, or a flexible disk. The computer program can then be installed in a computer, and the operations described above can be carried out so as to configure the control device. Herein, the control device can be an external device (for example, a personal computer) for the delivery server 30 or can be an internal device (for example, the control unit 33). Alternatively, the computer program (e.g., non-transitory computer readable medium including stored instructions executed by a microprocessor) can be stored, in a downloadable manner from the computer, in a disk device of a server device that is installed in a network such as the Internet. Meanwhile, the functions described above can be implemented in tandem using an OS (i.e., Operating System) and application software in cooperation. In that case, the portion other than the OS can be distributed by storing it in a medium or can be stored in a server device in a downloadable manner from the computer.

Of the processes described in the example implementation, all or part of the processes explained as being performed automatically can be performed manually. Similarly, all or part of the processes explained as being performed manually can be performed automatically by a related art method. The processing procedures, the control procedures, specific names, various data, and information including parameters described in the example implementations or illustrated in the drawings can be changed as required unless otherwise specified. For example, the variety of information explained with reference to the drawings is not limited to the information illustrated in the drawings.

The constituent elements of the device illustrated in the drawings are merely conceptual, and need not be physically configured as illustrated. The constituent elements, as a whole or in part, can be separated or integrated either functionally or physically based on various types of loads or use conditions.

Moreover, example implementations can be combined without causing any contradiction in the operation details.

### 7. HARDWARE CONFIGURATION

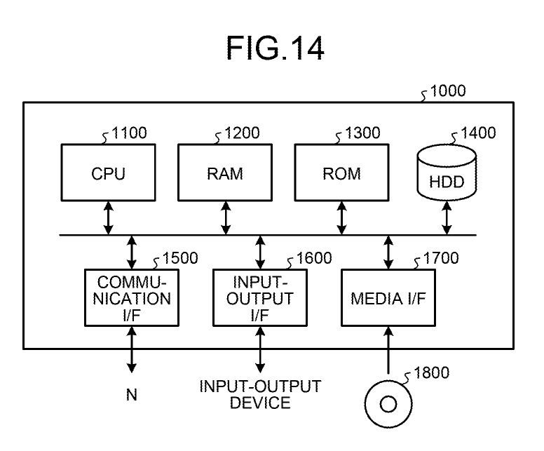

The delivery server 30 according to the example implementation and the modification example can be implemented using a computer 1000 having a configuration as illustrated in FIG. 14, for example. FIG. 14 is a diagram illustrating an example hardware configuration of a computer that implements the functions of the delivery server 30. The computer 1000 includes a CPU 1100, a RAM 1200, a ROM (i.e., Read Only Memory) 1300, an HDD (i.e., Hard Disk Drive) 1400, a communication interface (I/F) 1500, an input-output interface (I/F) 1600, and a media interface (I/F) 1700.

The CPU 1100 performs operations based on the computer programs (e.g., non-transitory computer readable medium including stored instructions executed by a microprocessor) stored in the ROM 1300 or the HDD 1400, and controls the other constituent elements. The ROM 1300 is used to store a boot program that is executed by the CPU 1100 at the time of booting the computer 1000, and to store computer programs (e.g., non-transitory computer readable medium including stored instructions executed by a microprocessor) that are dependent on the hardware of the computer 1000.

The HDD 1400 is used to store the computer programs (e.g., non-transitory computer readable medium including stored instructions executed by a microprocessor) executed by the CPU 1100 and to store the data used in the computer programs. The communication interface 1500 receives data from other devices via the network N and sends the data to the CPU 1100; and sends the data generated by the CPU 1100 to other devices via the network N.

The CPU 1100 controls the output devices, such as a display and a printer, and the input devices, such as a keyboard and a mouse, via the input-output interface 1600. The CPU 1100 obtains data from the input devices via the input-output interface 1600. Moreover, the CPU 1100 outputs the generated data to the output devices via the input-output interface 1600.

The media interface 1700 reads the computer programs (e.g., non-transitory computer readable medium including stored instructions executed by a microprocessor) or the data stored in a recording medium 1800, and provides the read information to the CPU 1100 via the RAM 1200. The CPU 1100 loads a computer program (e.g., non-transitory computer readable medium including stored instructions executed by a microprocessor) from the recording medium 1800 into the RAM 1200 via the media interface 1700, and executes the loaded computer program. Examples of the recording medium include an optical recording medium such as a DVD (i.e., Digital Versatile disk) or a PD (i.e., Phase change rewritable Disk); a magneto-optical recording medium such as an MO (Magneto-Optical disk); a table medium; a magnetic recording medium; and a semiconductor memory.

For example, when the computer 1000 functions as the delivery server 30 according to the example implementation, the CPU 1100 of the computer 1000 executes the computer programs (e.g., non-transitory computer readable medium including stored instructions executed by a microprocessor) loaded in the RAM 1200 and implements the functions of the control unit 33. The CPU 1100 of the computer 1000 reads the computer programs from the recording medium 1800 and executes them. As another example, the CPU 1100 can obtain the computer programs from some other device via the network N.

Herein, although the description is given about the example implementation of the application concerned, the technical scope thereof is not limited to the example implementation described above, and can be construed as embodying various deletions, alternative constructions, and modifications that may occur to one skilled in the art that fairly fall within the basic teaching herein set forth.

### 8. EFFECT

According to the present example implementation, the delivery server 30 generates a plurality of sets of configuration information, each of which contains some sets of location information from among the sets of location information of a plurality of sets of partitioned content obtained by partitioning the first-type content that includes at least either videos or sounds and that includes the second-type content within a reproduction range (e.g., predetermined reproduction range). Thus, the delivery server 30 does not send all sets of location information at once, and becomes able to get the user to view the second-type content.

The delivery server 30 includes a providing unit that sends the configuration information in a sequential manner at timings (e.g., predetermined timings) to a terminal device that reproduces the first-type content based on the configuration information. Thus, the delivery server 30 does not send all sets of location information at once, and becomes able to get the user to view the second-type content.

The delivery server 30 determines the reproduction positions of the second-type content. Hence, the delivery server 30 can insert the second-type content at desired reproduction positions.

After there is a request from the terminal device 100 for the location information containing the second-type content, the delivery server 30 determines the second-type content to be delivered. As a result, the delivery server 30 becomes able to get the user to view the second-type content as desired by the operator of the delivery server 30.

If the second-type content to be assigned to the first-type content is determined before the start of delivery of the first-type content; then, regardless of the fact that the second-type content has been assigned, there is a possibility that the user does not view the second-type content, such as in the case in which the user does not reproduce the first-type content till the position of the second-type content. When the second-type content is advertisement content, the operator of the delivery server 30 needs to perform inventory management by taking into account the possibility that the assigned advertisement content is not viewed, thereby making it difficult to perform inventory management of advertisements. However, by assigning the second-type content immediately before the delivery of the second-type content, it becomes possible to get the user to actually view the assigned second-type content. As a result, it becomes extremely easy to manage the display count of the second-type content (for example, inventory management of advertisements). Besides, regarding the second-type content not reproduced often (for example, the advertisement content having a large inventory), it also becomes possible to assign such advertisement content immediately before the reproduction, thereby making it extremely easy to manage the second-type content.

When there is a request from the terminal device 100 for the information meant for reproducing from a reproduction position that is after the second-type content by skipping the second-type content, the delivery server 30 sends the location information meant for reproducing the second-type content to the terminal device 100. As a result, the delivery server 30 becomes able to get the user to view the second-type content.

The delivery server 30 obtains the location information of a plurality of sets of partitioned content obtained by partitioning the first-type content that includes at least either videos or sounds and that includes the second-type content in a reproduction range (e.g., predetermined reproduction range). Moreover, to the terminal device 100 that reproduces the first-type content based on the location information, the delivery server 30 sends some sets of location information in a sequential manner at timings (e.g., predetermined timings). Since all sets of location information meant for reproducing the first-type content are not sent at once to the terminal device 100, the delivery server 30 can ensure that there is no free control on the reproduction of the first-type content in the terminal device 100. As a result, the delivery server 30 can get the user to view the second-type content.

Moreover, when there is a request from the terminal device 100 for the information meant for reproducing from a reproduction position that is after the second-type content by skipping the second-type content, the delivery server 30 sends the location information meant for reproducing the second-type content to the terminal device 100. As a result, the delivery server 30 becomes able to reliably get the user to view the second-type content. When the second-type content represents advertisement content, the management of whether or not it was possible to get the user to actually view the advertisements (for example, the inventory management of advertisements by the operator of the delivery server 30) becomes easier.

When there is a request from the terminal device 100 for the information meant for reproducing from a reproduction position that is after the second-type content by skipping the second-type content, the delivery server 30 sends the location information meant for reproducing the second-type content to the terminal device 100 and then sends the location information meant for reproducing the requested reproduction position to the terminal device 100. As a result, after getting the user to view the second-type content, the delivery server 30 can get the user to view from the desired reproduction position of the user.

After starting the transmission of the initial set of location information meant for reproducing the first-type content, the delivery server 30 determines the content to be treated as the second-type content. Subsequently, when the timing arrives for sending the location information meant for reproducing a reproduction range (e.g., predetermined reproduction range), the delivery server 30 sends, as the location information meant for reproducing the second-type content, the location information meant for reproducing the determined content to the terminal device 100. As a result, even after the delivery of the first-type content is started, the delivery server 30 can determine the content representing the second-type content at a timing (e.g., arbitrary timing) until the actual delivery of the second-type content. Hence, the management of whether or not it was possible to get the user to view the advertisements (for example, the inventory management of advertisements by the operator of the delivery server 30) becomes easier.

After there is a request from the terminal device 100 for the information meant for reproducing a reproduction range (e.g., predetermined reproduction range), the delivery server 30 determines the content to be treated as the second-type content. Subsequently, when there is a request from the terminal device 100 for the information meant for reproducing a reproduction range (e.g., predetermined reproduction range), the delivery server 30 determines the content to be treated as the second-type content and then sends the location information meant for reproducing the determined second-type content to the terminal device 100. As a result, even after the delivery of the first-type content is started, the delivery server 30 can determine the content representing the second-type content at a timing (e.g., arbitrary timing) until the actual delivery of the second-type content. Hence, the management of whether or not it was possible to get the user to view the advertisements (for example, the inventory management of advertisements by the operator of the delivery server 30) becomes easier.

Before the location information meant for reproducing the second-type content is sent to the terminal device 100, if there is a request from the terminal device 100 for the information meant for reproducing from a reproduction position that is after the second-type content, the delivery server 30 sends the location information meant for reproducing the second-type content to the terminal device 100. As a result, after getting the user to view the second-type content, the delivery server 30 can get the user to view from the desired reproduction position of the user.

Before the location information meant for reproducing the end of the second-type content (for example, starting the location information of the partitioned content including the end of the second-type content) is sent to the terminal device 100, if there is a request from the terminal device 100 for the information meant for reproducing from a reproduction position that is after the end of the second-type content, the delivery server 30 sends to the terminal device 100 the location information starting from the location information meant for reproducing the start of the second-type content (for example, starting from the location information of the partitioned content including the start of the second-type content). As a result, for example, even if a skipping operation (a seeking operation) is performed during the reproduction of the second-type content, the delivery server 30 becomes able to get the user to view the second-type content till the end.

After the location information meant for reproducing the second-type content is sent to the terminal device 100, if the timing for sending the location information meant for reproducing the second-type content arrives again, then the delivery server 30 does not send the location information meant for reproducing the second-type content to the terminal device 100, but sends to the terminal device the location information meant for reproducing from the reproduction position that is immediately after the second-type content (for example, the partitioned content including the reproduction position that is immediately after the second-type content). As a result, since the advertisement content is not shown to the user every time a skipping operation (a seeking operation) is performed, the feeling of discomfort brought to the user can be reduced.

After the location information meant for reproducing the second-type content is sent to the terminal device 100, when the timing for sending the location information meant for reproducing the second-type content arrives again, the delivery server 30 sends the location information related to the third-type content that is different than the second-type content. As a result, after getting the user to view the second-type content, the delivery server 30 can get the user to view from the desired reproduction position of the user.

When the location information meant for reproducing the second-type content is sent, the delivery server 30 records information indicating that the second-type content was reproduced. As a result, it becomes easier for the delivery server 30 to determine whether or not it was possible to get the user to view the second content. Moreover, when the second-type content represents advertisements, the management of whether or not it was possible to get the user to view the advertisements (for example, the inventory management of advertisements) becomes easier.

The delivery server 30 receives from the terminal device 100 the information indicating that the second-type content was reproduced. Before receiving from the terminal device 100 the information indicating that the second-type content was reproduced, if there is a request from the terminal device 100 for the information meant for reproducing from a reproduction position that is after the second-type content, the delivery server 30 sends the location information meant for reproducing the second-type content to the terminal device 100. As a result, the delivery server 30 becomes able to get the user to view the second-type content.

After the information indicating that the second-type content was reproduced is received from the terminal device 100, when the timing for sending the location information meant for reproducing the second-type content arrives again, the delivery server 30 does not send the location information meant for reproducing the second-type content, but sends to the terminal device 100 the location information meant for reproducing from the reproduction position that is immediately after the second-type content (for example, the location information of the partitioned content including the reproduction position that is immediately after the second-type content). As a result, after getting the user to view the second-type content, the delivery server 30 can get the user to view from the desired reproduction position of the user.

After the information indicating that the second-type content was reproduced is received from the terminal device 100, when the timing for sending the location information meant for reproducing the second-type content arrives again, the delivery server 30 sends the location information related to the third-type content that is different than the second-type content. As a result, the delivery server 30 can get the user to view different content than the second-type content.

Herein, although the description is given about the example implementation of the application concerned, the technical scope thereof is not limited to the example implementation described above, and can be construed as embodying various deletions, alternative constructions, and modifications that may occur to one skilled in the art that fairly fall within the basic teaching herein set forth.

Moreover, the terms “section”, “module”, and “unit” mentioned above can be read as “device” or “circuit”. For example, a processing unit can be read as a processing device or a processing circuit.

According to an aspect of the example implementation, it can be ensured that the portion of the content expected to be viewed by the user is viewed by the user.

Although the example implementations have been described with respect to specific example implementations for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device, comprising:
a control unit that generates a plurality of sets of configuration information, each of which contains sets of location information from a plurality of sets of partitioned content obtained by partitioning first-type content that includes videos and/or sounds, and that includes second-type content within a reproduction range.

2. The information processing device according to claim 1, further comprising the control unit providing the configuration information in a sequential manner at timings to a terminal device that reproduces the first-type content based on the configuration information.

3. The information processing device according to claim 1, further comprising the control unit determining a reproduction position of the second-type content.

4. The information processing device according to claim 2, further comprising the control unit that, after there is a request from the terminal device for the location information containing the second-type content, determines the second-type content to be delivered.

5. The information processing device according to claim 2, wherein, when there is request from the terminal device for information for reproducing from a reproduction position that is after the second-type content by skipping the second-type content, the control unit provides the location information meant for reproducing the second-type content to the terminal device.

6. The information processing device according to claim 5, wherein, when there is a request from the terminal device for information for reproducing from a reproduction position that is after the second-type content by skipping the second-type content, the control unit provides the location information meant for reproducing the second-type content to the terminal device and then provides the location information meant for reproducing the requested reproduction position to the terminal device.

7. The information processing device according to claim 5, wherein, before the location information for reproducing the second-type content is provided to the terminal device, when there is a request from the terminal device for information for reproducing from a reproduction position that is after the second-type content, the control unit provides the location information meant for reproducing the second-type content to the terminal device.

8. The information processing device according to claim 5, wherein, before the location information for reproducing an end of the second-type content is provided to the terminal device, when there is a request from the terminal device for information for reproducing from a reproduction position that is after the end of the second-type content, the control unit provides to the terminal device the location information starting from the location information for reproducing start of the second-type content.

9. The information processing device according to claim 5, wherein, after the location information for reproducing the second-type content is provided to the terminal device, when timing for providing the location information for reproducing the second-type content is received again, the control unit does not provide the location information for reproducing the second-type content to the terminal device, but provides the location information for reproducing reproduction position that is immediately after the second-type content.

10. The information processing device according to claim 5, wherein, after the location information for reproducing the second-type content is provided to the terminal device, when a timing for providing the location information for reproducing the second-type content arrives again, the control unit provides the location information related to a third-type content that is different than the second-type content.

11. The information processing device according to claim 5, further comprising the control unit performing recording control unit such that, when the location information for reproducing the second-type content is provided, information is recorded indicating that the second-type content has been reproduced.

12. The information processing device according to claim 5, further comprising the control unit receiving, from the terminal device, information indicating that the second-type content was reproduced, wherein
before information indicating that the second-type content was reproduced is provided to the terminal device, when there is a request received from the terminal device for information for reproducing from a reproduction position that is after the second-type content, the control unit provides the location information for reproducing the second-type content to the terminal device.

13. The information processing device according to claim 12, wherein, after information indicating that the second-type content was reproduced is received from the terminal device, when a timing for sending the location information for reproducing the second-type content arrives again, the control unit does not provide the location information for reproducing the second-type content, but provides to the terminal device the location information of partitioned content including reproduction position that is immediately after the second-type content.

14. The information processing device according to claim 12, wherein, after receiving information indicating that the second-type content was reproduced is received from the terminal device, when timing for sending the location information for reproducing the second-type content arrives again, the control unit does not provide the location information for reproducing the second-type content, but provides to the terminal device a third-type content that is different than the second-type content.

15. An information processing method implemented in an information processing device, comprising:
generating a plurality of sets of configuration information, each of which contains sets of location information from a plurality of sets of partitioned content obtained by partitioning first-type content that includes videos and/or sounds, and includes a second-type content within a reproduction range.

16. A non-transitory computer-readable storage medium including instructions executable by a microprocessor, wherein the instructions comprise:
generating a plurality of sets of configuration information, each of which contains sets of location information from a plurality of sets of partitioned content obtained by partitioning first-type content that includes videos and/or sounds, and that includes a second-type content within a reproduction range.

17. The information processing device of claim 1, wherein the control unit comprises a microprocessor that performs the generating the plurality of sets of configuration information, and further comprising a communication device that provides the configuration information to a terminal device, and a memory device that stores the plurality of sets of configuration information.

18. The information processing device of claim 17, wherein the information processing device comprises a delivery server.

19. The information processing device of claim 17, wherein the memory device comprises a plurality of databases.
